(19) United States
(12) Patent Application Publication
(10) Pub. No.: US 2011/0103436 A1
(43) Pub. Date: May 5, 2011

(54) TRANSMIT PSD CEILING IN PACKET-BASED OFDM SYSTEMS

(75) Inventors: Joon Bae Kim, Lexington, MA (US); Marcos T. Tzannes, Orinda, CA (US); Peter Niels Heller, Somerville, MA (US); Stuart Sandberg, Acton, MA (US)

(73) Assignee: AWARE, INC., Bedford, MA (US)

(21) Appl. No.: 12/743,873

(22) PCT Filed: Aug. 25, 2009
(86) PCT No.: PCT/US09/54849

§ 371 Date: Dec. 20, 2010

Related U.S. Application Data
(60) Provisional application No. 61/091,615, filed on Aug. 25, 2008.

(51) Int. Cl. H04B 1/38

(52) U.S. Cl. 375/219

(57) ABSTRACT

Adjusted maximum transmit PSD levels have an effect on the SNR. If the ADC noise is assumed to be the limiting factor, then there can be a benefit for reducing the maximum transmit PSD level. For example, by lowering the maximum transmit PSD level from −50 dBm/Hz to −70 dBm/Hz results in an increase in SNR for subcarriers above 30 M Hz. The SNR for subcarriers above 30 MHz can increase from 30 db (−80-(−110)) to 50 db (−80-(−130)). Therefore, by changing the maximum transmit PSD level, applying a ceiling on PSD mask, the aggregate sum of the available SNR's over the available subcarriers is therefore increasing the obtainable OFDM data rate. In other words, a maximum transmit PSD mask can be used to lower the transmit PSD value of at least one subcarrier which results in an increase in SNR for at least one subcarrier.

### RELATED APPLICATION DATA

This application claims the benefit of and priority under 35 U.S.C. §119(e) to U.S. Patent Application No. 61/091,615, filed Aug. 25, 2008, entitled “Maximum Transmit PSD Adjustment in Packet-Based OFDM Systems,” which is incorporated herein by reference in its entirety.

### BACKGROUND

### Field of the Invention

Exemplary aspects of the invention relate to communications systems. More specifically, exemplary aspects of the invention relate to communications systems where information is exchanged using packet-based transmissions based on Orthogonal Frequency Division Multiplexing (OFDM), also known as Multicarrier Modulation. More specifically, exemplary aspects of the invention relate to adjusting the transmit Power Spectral Density (PSD) level of subcarriers in the presence of multiple maximum allowed transmit PSD levels within a PSD mask defined over a shared channel, where multiple users communicate with one another using packet-based transmissions based on OFDM.

Considering multi-user communication environments where two or more users communicate with one another over a shared channel, e.g., a single frequency band, using packet-based transmission based on OFDM, a packet is usually formed by a preamble, header, and payload, and transmitted using time-sharing or contention-based media access methods. Examples of such systems include IEEE 802.11 (Wireless LAN) and IEEE 802.16 (WiMAX).

OFDM, also referred to as Discrete MultiTone (DMT) or multicarrier communications, divides the transmission frequency band into multiple subcarriers, also referred to as tones or subchannels, with each subcarrier individually modulating a bit or a collection of bits, where the number of bits modulated on each subcarrier may be the same (a constant or flat allocation of bits to subcarriers) or may vary (a variable or allocation of bits to subcarrier, also known as “bitloading”). If the PSD mask is not constant over a shared frequency band, in other words, the maximum allowed transmit PSD value is different for at least two subcarriers, and the difference is between the lowest and the highest mask level is large enough, the system either needs a high dynamic range Analog-to-Digital Converter (ADC) or Digital-to-Analog Converter (DAC), which increases the system complexity, or suffers from high ADC/DAC noise, which results in performance degradation at a receiver.

For a transmitting transceiver in an OFDM communications environment, an OFDM signal is the sum of a number of orthogonal sub-carriers, with baseband data on each sub-carrier being independently modulated commonly using quadrature amplitude modulation (QAM) or phase-shift keying (PSK). For baseband communications, the OFDM signal may be sent without being frequency up-shifted (or up-converted) or may be up-shifted (or up-converted by a carrier (Fus). For RF communications, the OFDM signal may be further up-shifted (or up-converted) by a RF carrier (Fc). One example of an RF-based OFDM transmitter is shown in FIG. 17 and an example of an RF-based OFDM receiver is shown in FIG. 18.

### SUMMARY

As used herein, the terms transmitter, transmitting transceiver and transmitting modem are used interchangeably, similarly, the terms receiver, receiving transceiver and receiving modem are used interchangeably as well as the terms modem and transceiver being used interchangeably.

FIG. 1 illustrates an example of a non-flat PSD mask found in Power Line Communications (PLC), which contains a large difference, 30 dB in the given example, in the maximum transmit PSD levels, depending on the frequency range.

FIG. 2 illustrates an example of the adjusted maximum transmit PSD level and its effect on the Signal-to-Noise Ratio (SNR). If the ADC noise is assumed to be the limiting factor, that is, the background noise is lower than −130 dBm/Hz, then this example illustrates the benefit of reducing the maximum transmit PSD level. In the example in FIG. 2, lowering the maximum transmit PSD level from −50 dBm/Hz (in the left figure) to −70 dBm/Hz (in the right figure) results in an increase in SNR for subcarriers above 30 MHz. The SNR for subcarriers above 30 MHz increased from 30 db (−80-(−110)) to 50 db (−80-(−130)).

Therefore, by changing the maximum transmit PSD level, applying a ceiling on PSD mask, the aggregate sum of the available SNR's over the available subcarriers is increased, therefore increasing the obtainable OFDM data rate. In other words, a maximum transmit PSD mask can be used to lower the transmit PSD value of at least one subcarrier which results in an increase in SNR for at least one subcarrier. Changing the maximum transmit PSD level can be referred to as a ceiling function, and therefore as discussed herein the term “transmit PSD ceiling” can be interchanged with “maximum transmit PSD value.”

In order to select the value of the transmit PSD ceiling level, messaging between a transmitter and a receiver is helpful. FIG. 3 illustrates an example of the conceptual communications paths between two transceivers. To assist with discussion herein, several parameters used herein are defined as:
ITPC_T: Initial transmit PSD ceiling value (dBm/Hz) of packets, as set by the transmitter.
PTPC_R: Proposed transmit PSD ceiling value (dBm/Hz) of packets, as set by the receiver.
ATPC_T: Actual transmit PSD ceiling value (dBm/Hz) of packets, as set by the transmitter.
HTPC_X: A bit field in the packet header transmitted over a communication path X (i.e., X=TRDP, TRMP, RTMP), which indicates the transmit PSD ceiling level (dBm/Hz) used for the current packet.
BAT_R: Bit allocation table per packet constructed by the receiver.
BAT_T: Bit allocation table per packet constructed by the transmitter.
TRDP: Data path from the transmitter to the receiver.
TRMP: Message path from the transmitter to the receiver.
RTMP: Message path from the receiver to the transmitter.

Accordingly, aspects of this invention are directed toward power spectral density management.

Additional aspects of the invention are directed toward techniques, procedures and protocols to adjust the transmit PSD ceiling level.

Even further aspects of the invention are directed toward a receiver-based approach for adjusting the transmit PSD ceiling level.

Further aspects are directed toward a transmitter-based approach to adjusting the transmit PSD ceiling level.

Additional aspects are related to a methodology or protocol for adjusting a transmit PSD ceiling.

Even further aspects are directed toward methods, techniques and protocols used during the training phase, for receiver-initiated PSD adjustment in both point-to-point communications and point-to-multipoint communications.

Even further aspects of the invention relate to methods, protocols and techniques used during the training phase for transmitter-initiated PSD adjustment and point-to-point communications and point-to-multipoint communications.

Aspects of the invention also relate to protocols, techniques and methods used during the data exchange phase for receiver-initiated power adjustment in point-to-point communications and point-to-multipoint communications.

Further aspects relate to protocols, techniques and methods used during the date exchange phase for transmitter-initiated power adjustment in point-to-point communications and point-to-multipoint communications.

Even further aspects of the invention relate to protocols, techniques and methods for transition into and out of a power-save mode for point-to-point communications.

Even further aspects of the invention relate to how the transmit PSD ceiling value is communicated between the various transceivers.

These and other features and advantages of this invention are described in, or are apparent from, the following detailed description of the exemplary embodiments.

### BRIEF DESCRIPTION OF THE DRAWINGS

The exemplary embodiments of the invention will be described in detail, with reference to the following figures, wherein:

FIG. 1 illustrates an exemplary PSD mask of a base band PLC channel;

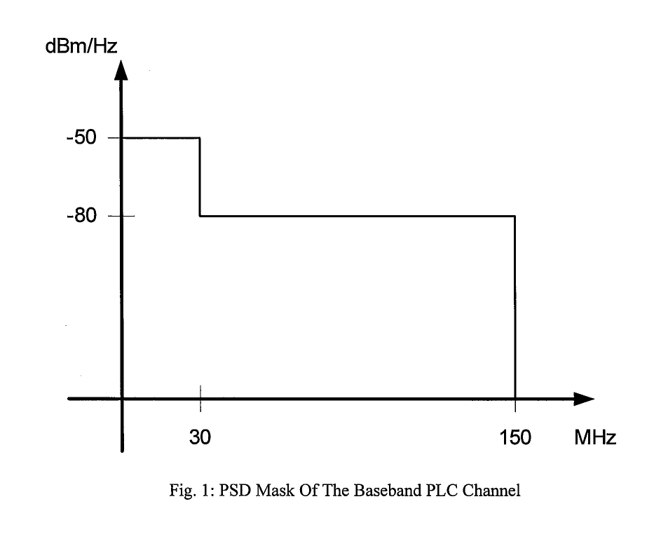

FIG. 2 illustrates an exemplary transmit PSD ceiling level adjustment according to this invention;

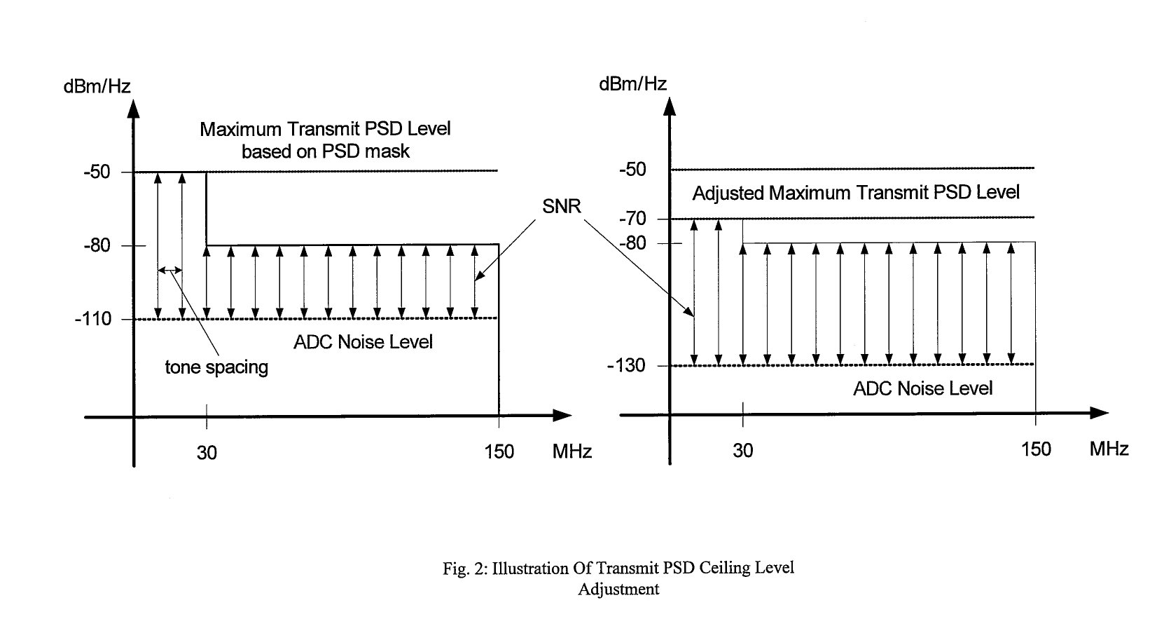

FIG. 3 is an example of conceptual communications paths between two transceivers according to this invention;

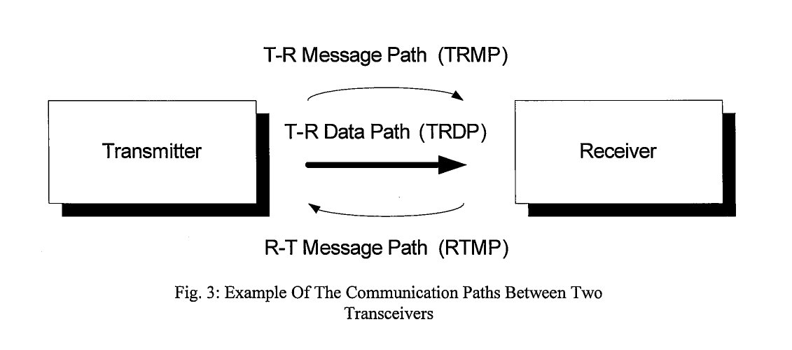

FIG. 4 is an exemplary communications system including two (or more) transceivers according to this invention;

FIG. 5 is a flowchart outlining an exemplary receiver-based approach to adjust the transmit PSD ceiling level according to this invention;

FIG. 6 is a flowchart outlining an exemplary method of adjusting the transmit PSD ceiling level for a transmitter-based approach according to this invention;

FIG. 7 is a flowchart outlining an exemplary method for executing transmit PSD adjustment according to this invention;

FIG. 8 is a flowchart outlining an exemplary method for a receiver-initiated PSD adjustment during the training phase for a point-to-point communications according to this invention;

FIG. 9 is a flowchart outlining an exemplary method of receiver-initiated PSD adjustment during the training phase for point-to-multipoint communications according to this invention;

FIG. 10 is a flowchart outlining an exemplary method of transmitter-initiated PSD adjustment for point-to-point communications according to this invention;

FIG. 11 is a flowchart outlining an exemplary method for transmitter-initiated PSD adjustment for point-to-multipoint communications according to this invention;

FIG. 12 is a flowchart outlining an exemplary method for receiver-initiated power adjustment during the data exchange phase for point-to-point communications according to this invention;

FIG. 13 is a flowchart outlining an exemplary method for receiver-initiated power adjustment during the data exchange phase for point-to-multipoint communications;

FIG. 14 is a flowchart outlining an exemplary method for transmitter-initiated power adjustment during the data exchange phase for point-to-point communications according to this invention;

FIG. 15 is a flowchart outlining an exemplary method for transmitter-initiated power adjustment during the data exchange phase for point-to-multipoint communications;

FIG. 16 is a flowchart outlining an exemplary method for power-saved mode transition in point-to-point communications;

FIGS. 17 and 18 illustrate an exemplary overview of the processes for OFDM communications; and

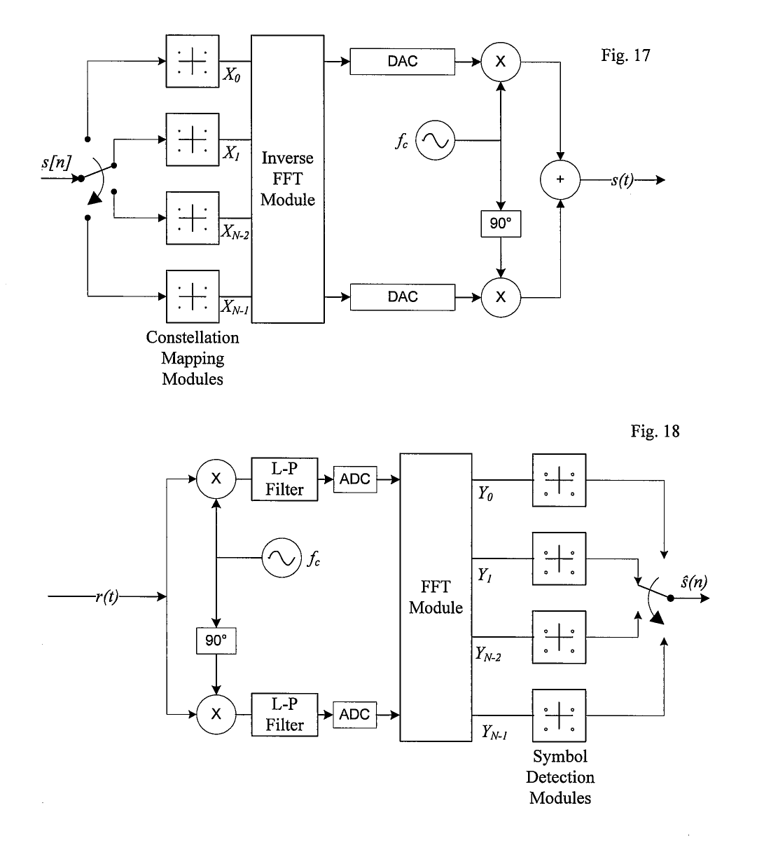

FIGS. 19-20 illustrate lab-measured results based on the exemplary embodiments of this invention.

### DETAILED DESCRIPTION

The exemplary embodiments of this invention will be described in relation to OFDM communications systems, as well as protocols, techniques and methods to adjust the transmit power spectral density. However, it should be appreciated, that in general, the systems and methods of this invention will work equally well for other types of communications environments.

The exemplary systems and methods of this invention will also be described in relation to multicarrier modems, such as powerline modems, coaxial cable modems, telephone wire modems, such as xDSL modems and vDSL modems, and wireless modems, and associated communications hardware, software and communications channels. However to avoid unnecessarily obscuring the present invention, the following description admits well-known structures and devices that may be shown in block diagram form or are otherwise summarized or known.

For purposes of explanation, numerous details are set forth in order to provide a thorough understanding of the present invention. It should be appreciated however that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured, and/or encrypted system. Thus, it should be appreciated that the components of the system can be combined into one or more devices, such as a modem, line card, or collocated on a particular node of a distributed network, such as a telecommunications network. As will be appreciated from the following description, and for reasons of computations efficiency, the components of this system can be arranged at any location within a distributed network without affecting the operation of the system. For example, the various components can be located in a domain master, a node, an domain management device, or some combination thereof. Similarly, one or more functional portions of this system could be distributed between a modem and an associated computing device.

Furthermore, it should be appreciated that the various links, including communications channel 5, connecting the elements (not shown) can be wired or wireless links or any combination thereof, or any other known or later developed element(s) capable of supplying and/or communicating data to and from the connected elements. The term module as used herein can refer to any known or later developed hardware, software, firmware, or combination thereof, that is capable of performing the functionality associated with that element. The terms determine, calculate, and compute, and variations thereof, as used herein are used interchangeably and include any type of methodology, process, technique, mathematical operation or protocol. The terms transmitting modem and transmitting transceiver as well as receiving modem and receiving transceiver are also used interchangeably herein.

Moreover, while some of the exemplary embodiments described are directed toward a transmitter portion of a transceiver performing certain functions, this disclosure is intended to include corresponding receiver-side functionality in both the same transceiver and/or another transceiver.

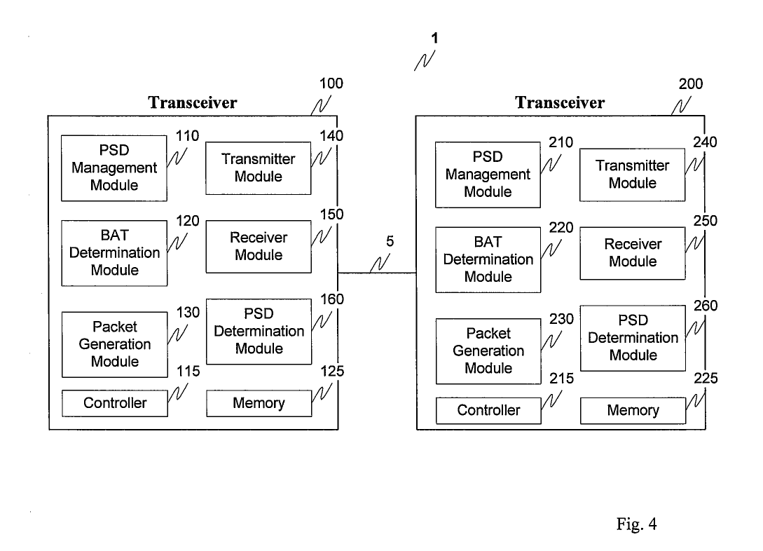

Certain exemplary embodiments of this invention relate to multi-carrier communications links, such as Discrete Multi-Tone (DMT). The term link is used herein to describe the process of initializing two transceivers and entering into steady-state data transmission mode. Also, the terms transceiver and modem have the same meaning and are used interchangeably. FIG. 4 illustrates an exemplary communications system 1. The communications system 1 includes transceiver 100 and transceiver 200. Transceiver 100 includes a PSD management module 110, BAT determination module 120, packet generation module 130, transmitter module 140, receiver module 150, PSD determination module 160, as well as other standard well known components such as controller 115 and memory 125. Similarly, transceiver 200 includes a PSD management module 210, BAT determination module 220, packet generation module 230, transmitter module 240, receiver module 250, PSD determination module 260, and standard well known components such as controller 215 and memory 225.

In operation, the transmit PSD ceiling level may be determined by the receiver and/or transmitter and/or another entity, such as management device or domain management device. Regardless of which device determines the transmit PSD ceiling level (or value), the determination and/or use of the transmit PSD ceiling level is a fundamental aspect of the invention.

Accordingly, in an exemplary embodiment of a receiving modem determining the transmit PSD ceiling, when a receiving modem is in a signal-quiet state, the receiver module, such as receiver module 250, may make two measurements of the composite noise PSD. One measurement is made with a high RX gain (PGA) setting, and the other is made with a low setting. From these two measurements, the receiver module 250, cooperating with controller 215 and memory 225, can estimate the ADC noise component (the noise entering the RX path subsequent to the PGA) and the line noise component (the noise entering the RX path prior to the PGA) of the composite noise PSD.

During a signal-active state, the receiver module 250 measures the PSD of the received packet. From this RX signal PSD, the known TX PSD mask, and the ITPC_T, the receiver module 250 can calculate the RX signal PSD that would result from any PTPC_R, as well as the corresponding PGA setting. Given the PGA setting, the receiver module 250, cooperating with the controller 215 and memory 225, can determine the corresponding composite noise PSD from the ACD noise and line noise PSDs estimated earlier. The ratio of the RX signal PSD, divided by the composite noise PSD can be referred to as the SNR, and is the basis for calculating the data rate associated with the particular PTPC_R. Repeating the SNR determination for various PTPC_R allows the receiving modem to select the value of PTPC_R that results in maximum data rate.

Alternatively or in addition, in an exemplary embodiment of a receiving modem determining the transmit PSD ceiling, the receiving modem may measure the SNR on a plurality of packets with at least two packets having a different PSD ceiling value. Based on the measured SNR for the plurality of packets, the receiving modem may determine transmit PSD ceiling value.

Alternatively or in addition, in an exemplary embodiment of a transmitting modem determining the transmit PSD ceiling, the transmitting modem may send a plurality of packets with at least two packets having a different PSD ceiling value to receiving modem. The receiving modem may then receive information on the data rate capability and/or SNR of the receiving modem for the various PSD ceiling values and may use this information to determine transmit PSD ceiling value.

Alternatively or in addition, in an exemplary embodiment of a transmitting modem determining the transmit PSD ceiling, in some applications such as home networking, the channel attenuation may not be a significant concern because most users (nodes) are located in close proximity. In this case, the transmitter module 140 could compute ATPC_T directly based on measured background noise. This approach may be sub-optimal compared to a receiver-based approach, but it does not require feedback from the receiver.

A technique for executing a transmit PSD adjustment includes one or more of the following exemplary steps. In a first step, the transmitting modem 100, cooperating with the packet generation module 130, sends at least one packet where at least two subscribers have a transmit PSD value that is different, and a transmit PSD ceiling value is used for subcarriers in the packet. For example, the PSD ceiling value may be used to determine the PSD or limit the PSD of at least one subcarrier. In one exemplary embodiment, the header portion of the packet contains the transmit PSD ceiling value. Alternatively, or in addition, the transmitting modem 100 may send the transmit PSD ceiling value in a data portion of the packet.

Next, a receiving modem 200 receives the at least one packet from the transmitting modem. Then, the receiving modem 200 determines, in cooperation with the PSD determination module 260, a new transmit PSD ceiling value. Then, the receiving modem sends at least one packet, with the cooperation of the packet generation module 230, containing the new transmit PSD ceiling value. The new transmit PSD ceiling value may be sent in the header portion of a packet, or may be sent in the data portion of a packet.

The transmitting modem 100 then receives the at least one packet from the receiving modem 200. The transmitter module 140 of the transmitting modem 100 sends at least one packet where at least two subscribers have a transmit PSD value that is different and a transmit PSD ceiling value is used for subcarriers in the packet. For example, the PSD ceiling value may be used to determine the PSD or limit the PSD of at least one subcarrier. This maximum PSD value in this step is different than the one used above in the first step. In one exemplary embodiment, the header portion of the packet contains the new transmit PSD ceiling value. Alternatively, or in addition, the transmitting modem may send the transmit PSD ceiling value in the data portion of the packet. This new transmit PSD ceiling value results in a change of the transmit PSD value of at last one subcarrier when compared to a packet sent with the transmit PSD ceiling value used in the first step. This transmit PSD ceiling value used by the transmitting modem in this step can be the same as the transmit PSD ceiling value sent by the receiving modem above or it can be different. If the receiving modem wants to change the transmit PSD ceiling value again, the process can repeat with the process returning to where the receiving modem receives at least one packet from the transmitting modem.

PSD adjustment can also be accomplished during a training phase. The training phase can be defined as during any communication link not used for passing of user data. This can include the registration phase, the multicast group formation phase, and the transceiver training phase. Point-to-point communication refers to communications between one transmitter and one receiver, whereas point-to-multipoint communication refers to communications between one transmitter and multiple receivers. During a training phase, only TRMP and RTMP are used, TRDP has not yet been established.

For ease of discussion, herein the transceiver 100 will be referred to as the “transmitting modem” and the transceiver 200 will be referred to as the “receiving modem.”

Receiver-Initiated PSD Adjustment

Point-to-Point Communications

An exemplary method for receiver-initiated PSD adjustment in a point-to-point communications environment includes one or more of the following steps:

Step 1: The transmitting modem 100 sets the transmit PSD value based on ITPC_T, and sends at least one packet, with the cooperation of the packet generation module 130 and/or the transmitter module 240, to the receiving modem 200 where the transmit PSD ceiling value is sent in the packet header. For example the transmitter module 140 may send a packet with the header containing a bit field that indicates the transmit PSD ceiling value for the packet (e.g. HTPC_TRMP=ITPC_T). Alternatively, or in addition, the transmitter module 140 may send ITPC_T as part of a message.

Step 2: The receiving modem 200, with the cooperation of the PSD management module 210, determines a proposed transmit PSD ceiling value (PTPC_R) and sends it back to the transmitting modem 100 via RTMP with the cooperation of the transmitter module 240. Note that PTPC_R can be sent as part of a message via RTMP. Alternatively, or in addition, PTPC_R may be sent in a packet with the header containing a bit field that indicates the transmit PSD ceiling value (e.g. via HTPC_RTMP).

Step 3: The transmitting modem 100 determines ATPC_T from PTPC_R (normally, ATPC_T=PTPC_R, but the transmitting modem may adjust the value based on its own discretion).

Step 4: The transmitting modem 100 changes, with the cooperation of the PSD management module 110, (i.e. reduces or increases) the transmit PSD value of at least one subcarrier with respect to Step 1 with the cooperation of the PSD management module 110, updates the header of the packet (i.e., the header contains a bit field that indicates the new transmit PSD ceiling value HTPC_TRMP=ATPC_T), and sends at least one packet to the receiving modem 200 with the cooperation of the transmitter module 140. Alternatively, or in addition, the transmitting modem 100 may send ATPC_T as part of a message.

Step 5: The receiving modem 200 may determine the BAT_R with the cooperation of the BAT determination module 220 and send the BAT_R to the transmitting modem 100 with the cooperation of the transmitter module 240 via RTMP.

Step 6: The transmitting modem 100 may respond to the receiving modem 200 via TRMP with the updated BAT_T, or it may use BAT_R as-is (i.e., BAT_T=BAT_R).

Step 7: At the beginning of the data exchange phase, the transmitting modem 100 transmits, with the cooperation of the transmitter module 140 and the packet generation module 130, at least one data packet to the receiving modem 200 where the actual transmit PSD ceiling value (ATPC_T) is sent in the packet header. For example, the transmitting modem may send a packet with the header containing a bit field that indicates the transmit PSD ceiling value for the packet (e.g., HTPC_TRDP=ATPC_T). The transmitting modem may also use BAT_T to pass data to the receiving modem. Alternatively or in addition, the transmitting modem 100 may send ATPC_T as part of a message.

Point-to-Multipoint Communication

An exemplary method for receiver-initiated PSD adjustment in a point-to-multipoint communications environment includes one or more of the following steps:

Step 1: The transmitting modem 100 sets the transmit PSD value based on (ITPC_T) with the cooperation of the PSD determination module 160, and sends, with the cooperation of the packet determination module and/or the transmitter module 240, at least one packet to a plurality of receiving modems where the value of the transmit PSD ceiling value is sent in the packet header. For example, the transmitting modem 100 may send a packet with the header containing a bit field that indicates the transmit PSD ceiling value for the packet (e.g. HTPC_TRMP=ITPC_T). Alternatively, the transmitting modem 100 may send ITPC_T as part of a message.

Step 2: Each receiving modem determines, with the cooperation of a PSD determination module, a proposed transmit PSD ceiling value (PTPC_R) and sends it back to the transmitting modem 100 via RTMP. Note that PTPC_R can be sent as part of a message via RTMP. Alternatively, or in addition, PTPC_R may be sent in a packet with the header containing a bit field that indicates the transmit PSD ceiling value (e.g. in the header portion of a packet (HTPC_RTMP)).

Step 3: The transmitting modem 100 receives, with the cooperation of a receiver module 150, and collects the plurality PTPC_R from all the receiving modems and determines ATPC_T. The ATPC_T may be determined from the plurality of PTPC_Rs in a number of ways. For example, the ATPC_T may be set to the maximum value of the plurality of PTPC_Rs. Alternatively, for example, the ATPC_T may be set to the minimum value of the plurality of PTPC_Rs. Alternatively, for example, the ATPC_T may be set to the average value of the plurality of PTPC_Rs. In general the ATPC_T may be set to a value based on the plurality of PTPC_Rs.

Step 4: The transmitting modem 100 changes, with the cooperation of the PSD management module 110, (i.e. reduces or increases) the transmit PSD value of at least one subcarrier with respect to Step 1, updates the header (i.e. the header contains a bit field that indicates the new transmit PSD ceiling value, HTPC_TRMP=ATPC_T), and sends, with the cooperation of the transmitter module 140, the at least one packet to the receiving modems. Alternatively, or in addition, the transmitting modem 100 may send ATPC_T as part of a message.

Step 5: Each receiving modem may determine, with the cooperation of a BAT determination module, the BAT_R and may send it to the transmitting modem 100 via RTMP.

Step 6: The transmitting modem 100 may construct the BAT_T, with the cooperation of the BAT determination module 120, based on multiple BAT_R's received from all the receiving modems, and may send it to all receiving modems via TRMP.

Step 7: At the beginning of a data exchange phase, the transmitting modem 100 transmits at least one data packet to the receiving modems where the actual transmit PSD ceiling value is sent in the packet header (i.e., HTPC_TRDP=ATPC_T). For example, the transmitting modem may send a packet with the header containing a bit field that indicates the transmit PSD ceiling value for the packet. The transmitting modem 100 may also use the BAT_T to pass data to the receiving modem(s). Alternatively, or in addition, the transmitting modem 100 may send ATPC_T as part of a message.

Transmitter-Initiated PSD Adjustment

Point-to-Point Communication

An exemplary method for transmitter-initiated PSD adjustment in a point-to-point communications environment includes one or more of the following steps:

Step 1: The transmitting modem 100 sets the transmit PSD value, with the cooperation of the PSD determination module 160, based on ITPC_T, and sends, with the cooperation of the transmitter module 140 and/or packet generation module 130, at least one packet to the receiving modem 200 where the transmit PSD ceiling value is sent in the packet header. For example, the transmitting modem may send a packet with the header containing a bit field that indicates the transmit PSD ceiling value for the packet (e.g. HTPC_TRMP=ITPC_T). Alternatively, or in addition, the transmitting modem 100 may send ITPC_T as part of a message.

Step 2: The transmitting modem 100 determines, with the cooperation of the PSD determination module 160, the actual transmit PSD ceiling level ATPC_T directly. For example, the transmitting modem may use measurements of background noise, DAC/ADC noise, signal power levels, etc. Alternatively, for example the transmitting modem may send a plurality of packets with at least two packets having a different PSD ceiling value to receiving modem and use SNR and/or data rate information received from the receiver to determine the actual transmit PSD ceiling value.

Step 3: The transmitting modem 100 changes, with the cooperation of the PSD management module 110, (i.e., reduces or increases) the transmit PSD value of at least one subcarrier with respect to Step 1, updates the header of the packet (i.e. the header contains a bit field that indicates the new transmit PSD ceiling value e.g. HTPC_TRMP=ATPC_T), and sends, with the cooperation of the transmitter module 140, at least one packet to the receiving modem 200. Alternatively, or in addition, the transmitting modem 100 may send ATPC_T as part of a message.

Step 4: The receiving modem 200 may determine, with the cooperation of the BAT determination module 220, the BAT_R and send it to the transmitting modem 100 via RTMP.

Step 5: The transmitting modem 100 may respond to the receiving modem 200 via TRMP with the updated BAT_T, or it may use BAT_R as-is (i.e., BAT_T=BAT_R).

Step 6: At the beginning of the data exchange phase, the transmitting modem 100 transmits at least one data packet to the receiving modem 200 where the actual transmit PSD value (ATPC_T) is sent in the packet header. For example, the transmitting modem may send a packet with the header containing a bit field that indicates the transmit PSD ceiling value for the packet (e.g. HTPC_TRDP=ATPC_T). The transmitting modem 100 may also use BAT_T to pass data to the receiving modem 200. Alternatively, or in addition, the transmitting modem 100 may send ATPC_T as part of a message.

Point-to-Multipoint Communication

An exemplary method for receiver-initiated PSD adjustment in a point-to-multipoint communications environment includes one or more of the following steps:

Step 1: The transmitting modem 100 sets, with the cooperation of the PSD determination module 160, the transmit PSD value based on (ITPC_T), and sends, with the cooperation of the packet determination module and/or the transmitter module 240 at least one packet to a plurality of receiving modems where the value of the transmit PSD ceiling value is sent in the packet header. For example, the transmitting modem 100 may send a packet with the header containing a bit field that indicates the transmit PSD ceiling value for the packet (e.g. HTPC_TRMP=ITPC_T). Alternatively, or in addition, the transmitting modem 100 may send ITPC_T as part of a message.

Step 2: The transmitting modem 100 determines, with the cooperation of the PSD determination module, the actual transmit PSD ceiling level ATPC_T directly. For example, the transmitting modem 100 may use measurements of background noise, DAC/ADC noise, signal power levels, etc. Alternatively, for example the transmitting modem may send a plurality of packets with at least two packets having a different PSD ceiling value to receiving modem and use SNR and/or data rate information received from the receiver to determine the actual transmit PSD ceiling value.

Step 3: The transmitting modem 100 changes, with the cooperation of the PSD management module 110, (i.e. reduces or increases) the transmit PSD value of at least one subcarrier with respect to Step 1, updates the header of the packet (i.e. the header contains a bit field that indicates the new transmit PSD ceiling value, HTPC_TRMP=ATPC_T), and sends at least one packet to the receiving modem(s). Alternatively, or in addition, the transmitting modem 100 may send ATPC_T as part of a message.

Step 4: Each receiving modem may determine, with the cooperation of a BAT determination module, the BAT_R and may send it, with the cooperation of a transmitter module, to the transmitting modem 100 via RTMP.

Step 5: The transmitting modem 100 may construct, with the cooperation of the BAT determination module 120, the BAT_T based on multiple BAT_R's received from all receiving modems, and may send it to all receiving modems via TRMP.

Step 6: At the beginning of the data exchange phase, the transmitting modem 100 transmits, with the cooperation of transmitter module 140, at least one data packet to the receivers where the actual transmit PSD ceiling value is sent in the packet header (i.e. HTPC_TRDP=ATPC_T). For example, the transmitting modem may send a packet with the header containing a bit field that indicates the transmit PSD ceiling values for the packet. The transmitting modem 100 may also use BAT_T to pass data to the receiving modem(s). Alternatively, or in addition, the transmitting modem 100 may send ATPC_T as part of a message.

Note that HTPC_X may not be necessary in the transmitter-based approach since the receiving modem does not need to know the actual transmit PSD level.

Data Exchange Phase

This section describes exemplary techniques and protocols used during the data exchange phase, which can be defined as a period where the transceivers exchange user data. The transmit PSD value power can be adjusted during the data exchange phase in order to one or more of dynamically adapt the time-varying channel and to save power. During the data exchange phase, TRDP is used as well as TRMP and RTMP.

Receiver-Initiated Power Adjustment

Point-to-Point Communication

An exemplary method for receiver-initiated power adjustment in a point-to-point communications environment includes one or more of the following steps:

Step 1: The transmitting modem 100 sends, with the cooperation of the transmitter module 140, at least one data packet to the receiving modem 200 where the transmit PSD ceiling value is sent in the packet header. For example, the transmitting modem 100 may send a packet with the header containing a bit field that indicates the transmit PSD ceiling value for the packet (e.g. HTPC_TRDP=ATPC_T). Alternatively, or in addition, the transmitting modem 100 may send ATPC_T as part of a message.

Step 2: The receiving modem 200 requests, with the cooperation of the PSD management module 210, to change the transmit PSD ceiling level by sending a new proposed maximum PSD value (PTPC_R) to the transmitting modem 100 with the cooperation of the transmitter module 240. The PTPC_R may be sent as part of a message via RTMP. Alternatively, or in addition, the new proposed PTPC_R may be sent in the header portion of a packet. For example, the transmitting modem may send a packet with the header containing a bit field that indicates the transmit PSD ceiling values for the packet, e.g., PTPC_R may be sent via HTPC_RTMP or HTPC_RTDP.

Step 3: The transmitting modem 100 may reject the request by sending, for example, a NACK (or equivalent signal or symbol) to the receiving modem 200, or may not respond in time (which causes a timeout). If the transmitting modem 100 accepts the request, the transmitting modem 100 determines ATPC_T from PTPC_R (normally, ATPC_T=PTPC_R, but the transmitting modem 100 may adjust the value based on its own discretion).

Step 4: The transmitting modem 100, with the cooperation of the PSD management module 110, changes (i.e. reduces or increases) the transmit PSD value of at least one subcarrier with respect to Step 1, updates the header of the packet (i.e. header contains a bit field that indicates the new transmit PSD ceiling value, HTPC_TRMP=ATPC_T or HTPC_TRDP=ATPC_T), and sends at least one data or message packet to the receiving modem 200. Alternatively, or in addition, the transmitting modem 100 may send ATPC_T as part of a message.

Step 5: The receiving modem 200, with the cooperation of the BAT determination module 220, may determine the BAT_R based on the transmitted packet and may send the BAT_R to the transmitting modem 100 via RTMP.

Step 6: The transmitting modem 100 may respond to the receiving modem 200 via TRMP with the updated BAT_T, or it may use BAT_R as-is (i.e., BAT_T=BAT_R).

Step 7: The transmitting modem 100, with the cooperation of the transmitter module 140, transmits at least one data packet to the receiving modem 200 where the actual transmit PSD ceiling (ATPC_T) is sent in the packet header. For example, the transmitting modem may send a packet with the header containing a bit field that indicates the transmit PSD ceiling values for the packet (i.e. HTPC_TRDP=ATPC_T). The transmitting modem 100 may also use BAT_T to pass data to the receiving modem 200. Alternatively, or in addition, the transmitting modem 100 may send ATPC_T as part of a message.

Step 8: If the receiving modem 200 wants to change the maximum power level, the process returns to Step 2.

Point-to-Multipoint Communication

An exemplary method for receiver-initiated power adjustment in a point-to-multipoint communications environment includes one or more of the following steps:

Step 1: The transmitting modem 100 sends at least one data packet to a plurality of receiving modems where the transmit PSD ceiling value is sent in the packet header. For example the transmitting modem 100 may send a packet with HTPC_TRDP=ATPC_T. Alternatively, or in addition, the transmitting modem 100 may send ATPC_T as part of a message.

Step 2: The receiving modems request to change the transmit PSD ceiling level by sending a new proposed maximum PSD value (PTPC_R) to the transmitter. The PTPC_R may be sent as part of a message via RTMP. Alternatively, or in addition, the new proposed PTPC_R may be sent in the header portion of a packet, e.g., PTPC_R may be sent via HTPC_RTMP or HTPC_RTDP.

Step 3: The transmitting modem 100 may reject the request by sending a NACK to the receiving modems or may not respond in time (causing a timeout). If the transmitting modem 100 accepts the request, the transmitting modem with the cooperation of the PSD determination module 160 determines ATPC_T from the PTPC_Rs received from the receiving modems. The ATPC_T may be determined from the plurality of PTPC_Rs in a number of ways. For example, the ATPC_T may be set to the maximum value of the plurality of PTPC_Rs. Alternatively, for example, the ATPC_T may be set to the minimum value of the plurality of PTPC_Rs. Alternatively, for example, the ATPC_T may be set to the average value of the plurality of PTPC_Rs. In general the ATPC_T may be set to a value based on the plurality of PTPC_Rs.

Step 4: The transmitting modem 100, with the cooperation of the PSD management module 110, changes (i.e. reduces or increases) the transmit PSD value of at least one subcarrier with respect to Step 1, updates the header of the packet (i.e., the header contains a bit field that indicates the new transmit PSD ceiling value HTPC_TRMP=ATPC_T or HTPC_TRDP=ATPC_T), and sends, with the cooperation of the transmitter module 140, at least one data or message packet to the receivers. Alternatively, or in addition, the transmitting modem 100 may send ATPC_T as part of a message.

Step 5: Each receiving modem may determine, with the cooperation of a BAT determination module, a new BAT_R based on the new transmitted packet and may send it to the transmitting modem 100 via RTMP.

Step 6: The transmitting modem 100 may construct the BAT_T based on multiple BAT_R's received from receiving modems, and may send the BAT_T to the receiving modems via TRMP.

Step 7: The transmitting modem 100, with the cooperation of the transmitter module 140, transmits at least one data packet to the receivers where the actual transmit PSD value (ATPC_T) is sent in the packet header. For example, the transmitting modem may send a packet with the header containing a bit field that indicates the transmit PSD ceiling values for the packet (e.g. HTPC_TRDP=ATPC_T). The transmitting modem 100 may also use BAT_T to pass data to the receiving modem(s). Alternatively, or in addition, the transmitting modem 100 may send ATPC_T as part of a message.

Step 8: If the receiving modem(s) wants to change the maximum power level again, the process returns to Step 2.

Transmitter-Initiated Power Adjustment

Point-to-Point Communication

An exemplary method for transmitter-initiated power adjustment in a point-to-point communications environment includes one or more of the following steps:

Step 1: The transmitting modem 100 sends at least one data packet to the receiving modem 200 where the transmit PSD ceiling value is sent in the packet header. For example, the transmitting modem 100 may send a packet with with the header containing a bit field that indicates the transmit PSD ceiling values for the packet (e.g. HTPC_TRDP=ATPC_T.) Alternatively, or in addition, the transmitting modem 100 may send ATPC_T as part of a message.

Step 2: The transmitting modem 100, with the cooperation of the PSD determination module 160, determines the actual transmit PSD ceiling level ATPC_T directly. For example, the transmitting modem 100 may use measurements of background noise, DAC/ADC noise, signal power levels, etc. Alternatively, for example the transmitting modem may send a plurality of packets with at least two packets having a different PSD ceiling value to receiving modem and use SNR and/or data rate information received from the receiver to determine the actual transmit PSD ceiling value.

Step 3: The transmitting modem 100, with the cooperation of the PSD management module 110, changes (i.e. reduces or increases) the transmit PSD value of at least one subcarrier with respect to Step 1, updates the header of the packet (i.e. the header contains a bit field that indicates the new transmit PSD ceiling value, HTPC_TRMP=ATPC_T or HTPC_TRDP=ATPC_T), and sends at least one data or message packet to the receiving modem. Alternatively, or in addition, the transmitting modem 100 may send ATPC_T as part of a message.

Step 4: The receiving modem 200 may determine, with the cooperation of the BAT determination module 220, the BAT_R and send it, with the cooperation of transmitter module 240, to the transmitting modem 100 via RTMP.

Step 5: The transmitting modem 100 may respond to the receiving modem 200 via TRMP with the updated BAT_T, or it may use BAT_R as-is (i.e., BAT_T=BAT_R).

Step 6: The transmitting modem 100 transmits, with the cooperation of the packet determination module 130, at least one data packet to the receiving modem 200 where the actual transmit PSD ceiling (ATPC_T) is sent in the packet header (i.e. HTPC_TRDP=ATPC_T). For example, the transmitting modem may send a packet with the header containing a bit field that indicates the transmit PSD ceiling values for the packet. The transmitting modem 100 may also use BAT_T to pass data to the receiving modem 200. Alternatively, or in addition, the transmitting modem 100 may send ATPC_T as part of a message.

Step 7: If the transmitting modem 200 wants to change the maximum power level again, the process returns to Step 2.

Point-to-Multipoint Communication

An exemplary method for transmitter-initiated power adjustment in a point-to-multipoint communications environment includes one or more of the following steps:

Step 1: The transmitting modem 100 sends, with the cooperation of transmitter module 140, at least one data packet to a plurality of receiving modems where the value of the transmit PSD ceiling value is sent in the packet header. For example, the transmitting modem 100 may send a packet with the header containing a bit field that indicates the transmit PSD ceiling value for the packet (e.g. HTPC_TRDP=ATPC_T). Alternatively, or in addition, the transmitter may send ATPC_T as part of a message.

Step 2: The transmitting modem 100 determines, with the cooperation of the PSD determination module 160, the actual transmit PSD ceiling level ATPC_T directly. For example, the transmitting modem 100 may use measurements of background noise, DAC/ADC noise, signal power levels, etc. Alternatively, for example the transmitting modem may send a plurality of packets with at least two packets having a different PSD ceiling value to receiving modem and use SNR and/or data rate information received from the receiver to determine the actual transmit PSD ceiling value.

Step 3: The transmitting modem 100, with the cooperation of the PSD management module 110, changes (i.e., reduces or increases) the transmit PSD value of at least one subcarrier with respect to Step 1, updates the header of the packet (i.e. the header contains a bit field that indicates the new transmit PSD ceiling value, HTPC_TRMP=ATPC_T or HTPC_TRDP=ATPC_T), and sends at least one message or data packet to the receiving modems. Alternatively, or in addition, the transmitting modem 100 may send ATPC_T as part of a message.

Step 4: Each receiving modem may determine the BAT_R and may send it to the transmitting modem 100 via RTMP.

Step 5: The transmitting modem 100 may construct, with the cooperation of the BAT determination module 120, the BAT_T based on multiple BAT_R's received from all the receiving modems, and may send the BAT_T to all receiving modems via TRMP.

Step 6: The transmitting modem 100 transmits, with the cooperation of the transmitter module 140, at least one data packet to the receiving modems where the actual transmit PSD ceiling (ATPC_T) is sent in the packet header (i.e. HTPC_TRDP=ATPC_T). For example, the transmitting modem may send a packet with the header containing a bit field that indicates the transmit PSD ceiling values for the packet. The transmitting modem 100 may also use BAT_T to pass data to the receiving modems. Alternatively, or in addition, the transmitting modem 100 may send ATPC_T as part of a message.

Step 7: If the transmitting modem 100 wants to change the maximum power level again, the process returns to Step 2.

Power-Save Mode Transition

Point-to-Point Communication

An exemplary method for a power-save mode transition in a point-to-point communications environment includes one or more of the following steps:

Step 1: The transmitting modem 100 can notify the receiving modem 200 (or vice versa) ahead of time so that the other side can prepare the transition to power-save mode—Note that this optional step may be bypassed.

Step 2: The transmitting modem 100 initiates a transition to the power-save mode by using an ATPC_T and BAT_T that results in lower power. For example, these two parameters can be predefined, known and stored in memory by the transmitting modem 100 and receiving modem 200 in advance to entering the lower power mode. For example, the parameters can be obtained from the receiving modem 200 during the training phase or during a data exchange phase. When the transmitting modem 100 is ready, the transmitting modem 100 changes, with the cooperation of the PSD management module 110, the transmitted power, and uses HTPC_TRDP=ATPC_T and BAT_T to pass data to the receiving modem 200 with the updated setting. For example, the transmitting modem may send a packet with the header containing a bit field that indicates the transmit PSD ceiling values for the packet, wherein the transmit PSD value results in low power, or a power reduction at the transmitter and/or receiver.

The transition out of power-save mode can be done in a similar manner.

The methods and techniques above state that the transmit PSD ceiling value is sent in the header portion of the packet or in a message. For example, the packet header may contains a bit field that indicates the transmit PSD ceiling values for the packet. This is not restricted only to the exact value of transmit PSD ceiling value being used. In fact any information that can be used to determine or derive a transmit PSD ceiling value can be sent. For example, a predefined bit field with X bits could be used. For example if X=4, the bit value of 0000 could be used to indicate one transmit PSD ceiling value in dBm/Hz, the value 0001 could be used to indicate another transmit PSD ceiling value in dBm/Hz, and so on. Alternatively, or in addition, the value of the difference, e.g., a delta, in the new transmit PSD ceiling value with respect to the previously-used maximum PSD value could be sent. In this case a predefined bit field with X bits could be also used. For example if X=4, the bit value of 0000 could be used to indicate one difference in the transmit PSD ceiling value, the value 0001 could be used to indicate another difference in the transmit PSD ceiling value, and so on. Alternative methods for indicating the new transmit PSD ceiling value can also be used.

While the methods and techniques above describe the transmit PSD ceiling value as a single value for all the subcarriers in the packet, the transmit PSD ceiling value can be different for sets of subcarriers (e.g., frequency bands). For example, there could be one transmit PSD ceiling value for a first set of subcarriers (e.g., between 0 and 30 MHz) and a second transmit PSD ceiling value for a second set of subcarriers (e.g., between 30 and 100 MHz). Alternatively, there could be a transmit PSD ceiling value for each subcarrier in the packet.

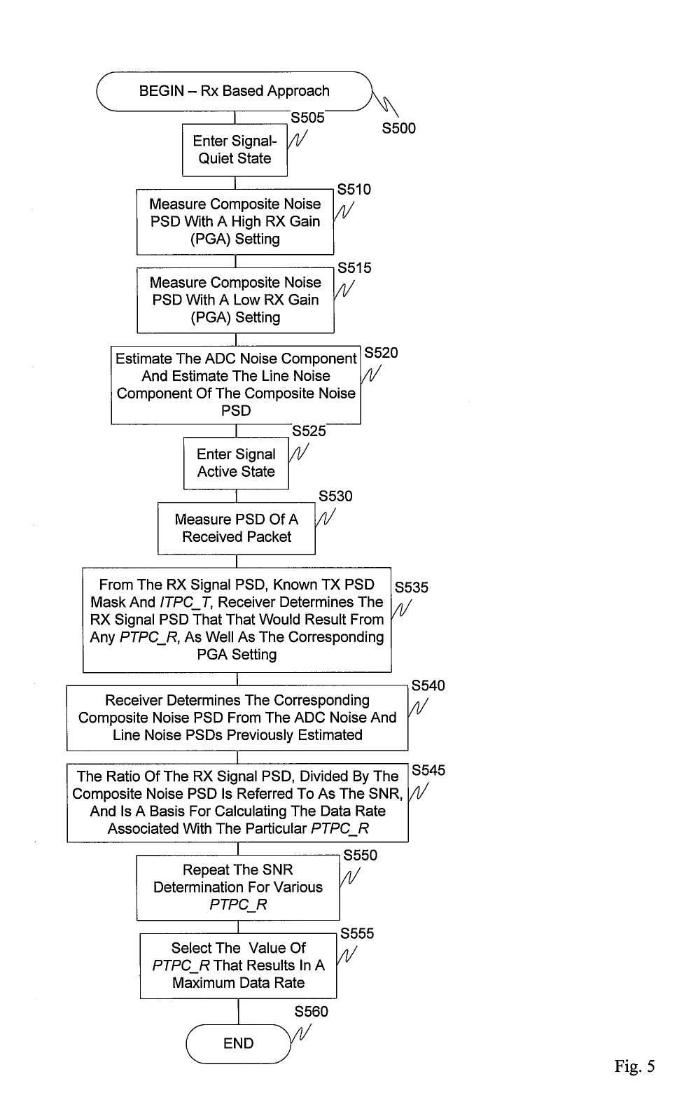

FIGS. 5-16 outline exemplary methods for PSD management according to this invention.

Adjusting the Transmit PSD Ceiling Level

Exemplary Receiver-Based Adjustment of the Transmit PSD ceiling Level

An exemplary approach is outlined for a receiver to determine the transmit PSD ceiling level. While other methods are possible, the use of a transmit PSD ceiling level (or value) is fundamental.

Control Begins in Step S500 with control continuing to step S505.

In step S505, and during a signal-quiet state, the receiver makes two measurements of the composite noise PSD. One measurement in step S510 is made with a high RX gain (PGA) setting, and the other in step S520 is made with a low setting. From these two measurements, the receiver estimates in step S520 the ADC noise component (the noise entering the RX path subsequent to the PGA) and the line noise component (the noise entering the RX path prior to the PGA) of the composite noise PSD.

During a signal-active state in step S525, the receiver measures the PSD of the received packet. From this received signal PSD, the known transmit PSD mask, and ITPC_T, the receiver in step S535 can determine the receive signal PSD that would result from any PTPC_R, as well as the corresponding PGA setting. Given the PGA setting, the receiver can determine in step S540 the corresponding composite noise PSD from the ADC noise and line noise PSDs estimated earlier. The ratio of the receive signal PSD in step S545, divided by the composite noise PSD is referred to as the SNR, and is a basis for calculating the data rate associated with the particular PTPC_R. Repeating the SNR determination in step S550 for various PTPC_R allows the receiver to select the value in step S555 of PTPC_R that results in maximum data rate.

Exemplary Transmitter-Based Approach

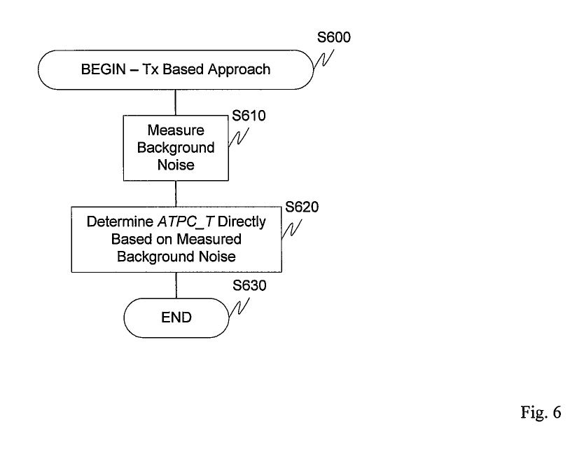

This section in conjunction with FIG. 6 describes one exemplary approach for a transmitter to determine the transmit PSD ceiling level. While other methods are possible, the use of a transmit PSD ceiling level is fundamental.

In some applications such as home networking the channel attenuation may not be a significant concern because most users (e.g., nodes) are located in close proximity. Control begins in step S600 and in this case the transmitter may compute ATPC_T directly in step S620 based on a measure of background noise in step S610. This approach may be sub-optimal compared to the receiver-based approach, but one exemplary advantage is that it does not require feedback from the receiver.

Protocol to Execute Transmit PSD Adjustment

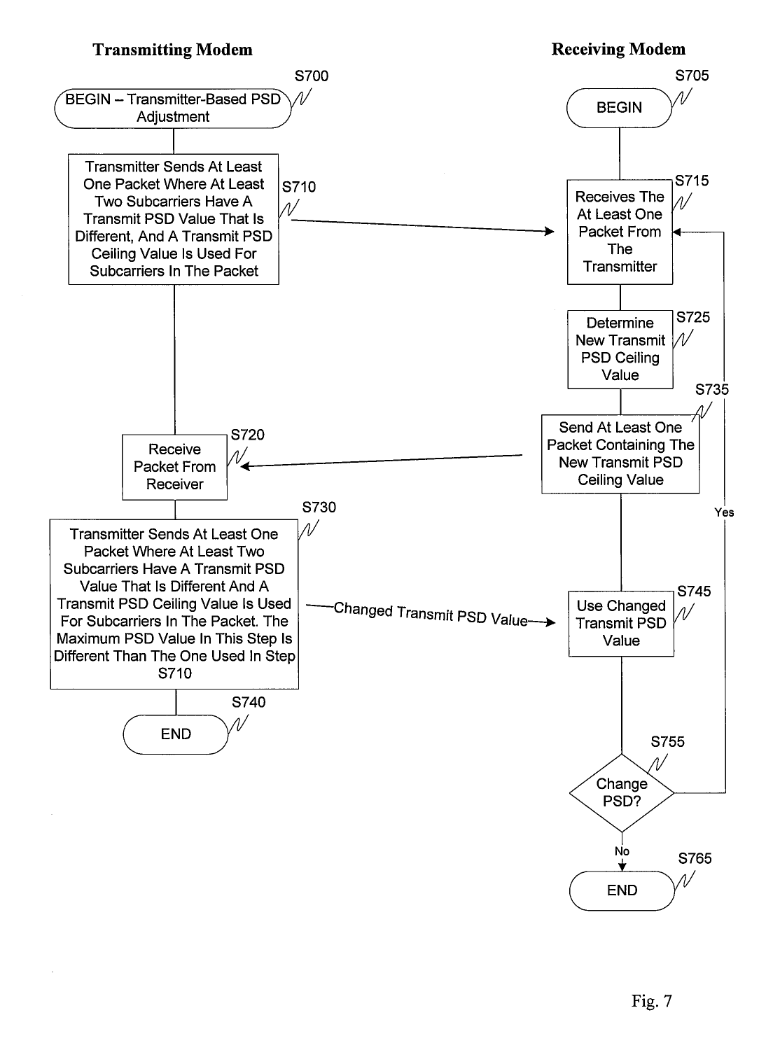

An exemplary method for a transmitter-based transmit PSD ceiling adjustment comprises one or more of the following steps as outlined in FIG. 7:

Control begins in step S700 with control continuing to step S710. In step S710 the transmitter sends at least one packet where at least two subcarriers have a transmit PSD value that is different and a transmit PSD ceiling value is used for subcarriers in the packet. For example, the PSD ceiling value may be used to determine the PSD or limit the PSD of at least one subcarrier. In one embodiment, the header portion of the packet contains the transmit PSD ceiling value. Alternatively, or in addition, the transmitter may send the transmit PSD ceiling value in the data portion of a packet.

Next, in step S715 the receiver receives the at least one packet from the transmitter. Then, in step S725 the receiver determines a new transmit PSD ceiling value. Control then continues to step S735.

In step S735, the receiver sends at least one packet containing the new transmit PSD ceiling value. The new transmit PSD ceiling value may be sent in the header portion of a packet or may be sent in the data portion of a packet. Next, in step S720 the transmitter receives the at least packet from the receiver. Then in step S730 the transmitter sends at least one packet where at least two subcarriers have a transmit PSD value that is different and a transmit PSD ceiling value is used for subcarriers in the packet. For example, the PSD ceiling value may be used to determine the PSD or limit the PSD of at least one subcarrier. This maximum PSD value in this step is different than the one used in step S710.

In one embodiment, the header portion of the packet contains the new transmit PSD ceiling value. Alternatively, or in addition, the transmitter may send the transmit PSD ceiling value in the data portion of a packet. This new transmit PSD ceiling value results in a change of the transmit PSD value of at least one subcarrier when compared to a packet sent with the transmit PSD ceiling value used in Step S710. The transmit PSD ceiling value used by transmitter in this step may be the same as the transmit PSD ceiling value sent by the receiver Step S735.

If the receiver, after receiving and commencing usage of the changed transmit PSD value in step S745, wants to change the transmit PSD ceiling value again in step S755, control jumps back to step S715, otherwise control continues to step S765 where the control sequence ends.

Exemplary Receiver-Initiated PSD Adjustment Method

Point-to-Point Communications

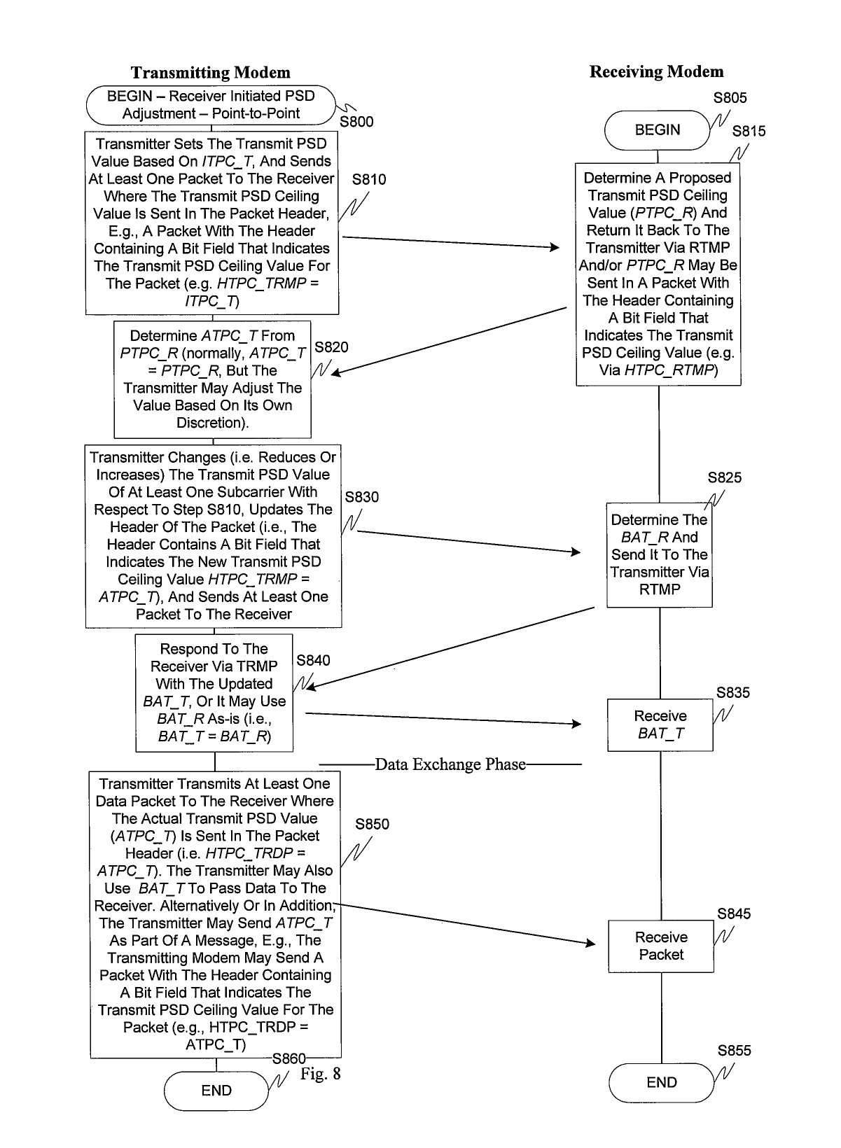

An exemplary method for receiver-initiated PSD adjustment in a point-to-point communications environment includes one or more of the following steps as outlined in FIG. 8:

Control begins in step S800 with control continuing to step S810.

In step S810 the transmitter sets the transmit PSD value based on ITPC_T, and sends at least one packet to the receiver where the transmit PSD ceiling value is sent in the packet header. For example the transmitter may send a packet with HTPC_TRMP=ITPC_T. Alternatively, or in addition, the transmitter may send ITPC_T as part of a message.

Next, in step S815 the receiver determines a proposed transmit PSD ceiling value (PTPC_R) and sends it back to the transmitting modem 100 via RTMP. Note that PTPC_R can be sent as part of a message via RTMP. Alternatively or in addition, PTPC_R may be sent via HTPC_RTMP.

Then, in step S820 the transmitter determines ATPC_T from PTPC_R (normally, ATPC_T=PTPC_R, but the transmitter may adjust the value based on its own discretion). In step S830 the transmitter changes (i.e. reduces or increases) the transmit PSD value of at least one subcarrier with respect to step S810 updates the header of the packet (i.e., HTPC_TRMP=ATPC_T), and sends at least one packet to the receiver. Alternatively, or in addition, the transmitter may send ATPC_T as part of a message.

In step S825, the receiver may determine the BAT_R and send the BAT_R to the transmitter via RTMP. In step S840, the transmitter may respond to the receiver via TRMP with the updated BAT_T, or it may use BAT_R as-is (i.e., BAT_T=BAT_R).

In step S850, at the beginning of the data exchange phase, the transmitter transmits at least one data packet to the receiver, which is received in step S845, where the actual transmit PSD ceiling (ATPC_T) is sent in the packet header (i.e., HTPC_TRDP=ATPC_T). The transmitter may also use BAT_T to pass data to the receiver. Alternatively, or in addition, the transmitting modem may send ATPC_T as part of a message.

Point-to-Multipoint Communication

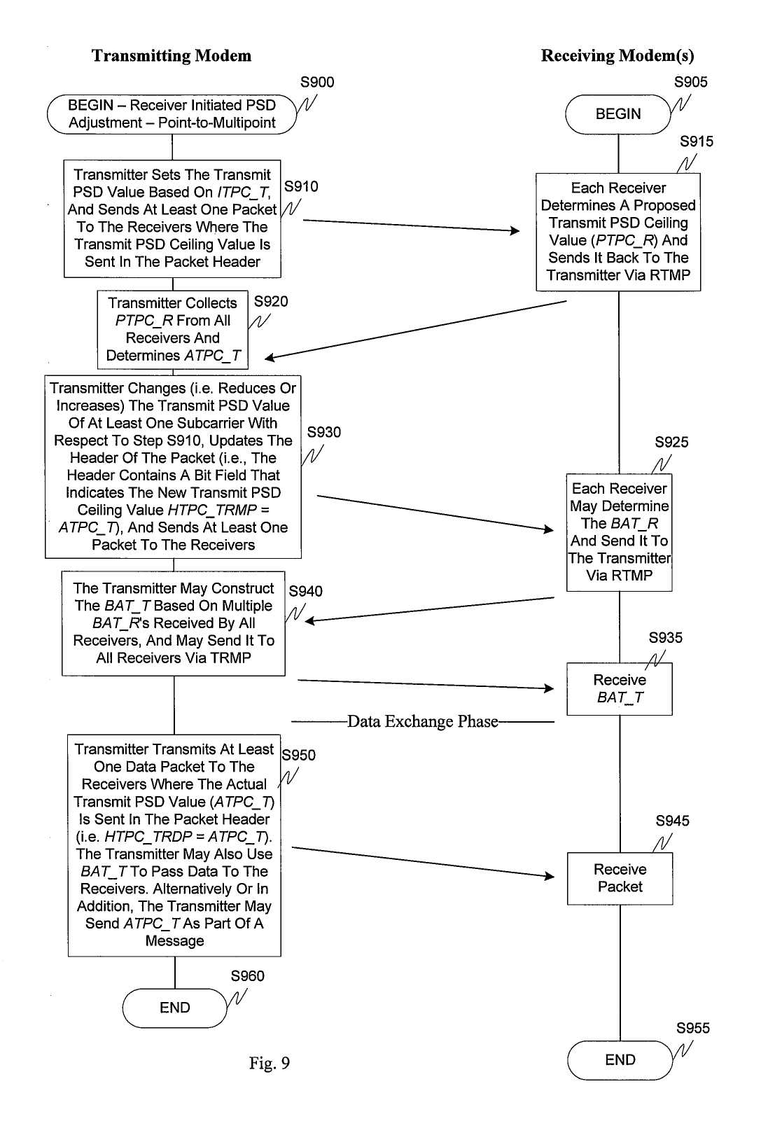

An exemplary method for receiver-initiated PSD adjustment in a point-to-multipoint communications environment includes one or more of the following steps as outlined in FIG. 9:

Control begins in step S900 and continues to step S910. In step S910, the transmitter sets the transmit PSD value based on (ITPC_T) and sends at least one packet to a plurality of receiving modems where the value of the transmit PSD ceiling value is sent in the packet header. For example, the transmitter may send a packet with HTPC_TRMP=ITPC_T. Alternatively, or in addition, the transmitter may send ITPC_T as part of a message.

Next, in step S915 each receiver determines a proposed transmit PSD ceiling value (PTPC_R) and sends it back to the transmitting modem via RTMP. Note that PTPC_R can be sent as part of a message via RTMP. Alternatively, or in addition, PTPC_R may be in the header portion of a packet (HTPC_RTMP).

Then, in step S920, the transmitter receives and collects the PTPC_R from all the receiving modems and determines ATPC_T. As discussed above, The ATPC_T may be determined from a plurality of PTPC_Rs in a number of ways.

In step S930 the transmitter changes (i.e., reduces or increases) the transmit PSD value of at least one subcarrier with respect to step S910, updates the header (i.e., HTPC_TRMP=ATPC_T), and sends the at least one packet to the receiving modems. Alternatively, or in addition, the transmitter may send ATPC_T as part of a message.

Next, in step S925 each receiving modem may determine the BAT_R and may send it to the transmitting modem via RTMP. Then, in step S940 the transmitter may construct the BAT_T based on multiple BAT_R's received from all the receivers, and may send it to all receivers via TRMP.

In step S950, and at the beginning of a data exchange phase, the transmitter transmits at least one data packet to the receivers, which is received in step S945, where the actual transmit PSD ceiling value is sent in the packet header (i.e., HTPC_TRDP=ATPC_T). The transmitter may also use the BAT_T to pass data to the receiver(s). Alternatively, or in addition, the transmitter may send ATPC_T as part of a message.

Exemplary Transmitter-Initiated PSD Adjustment Method

Point-to-Point Communication

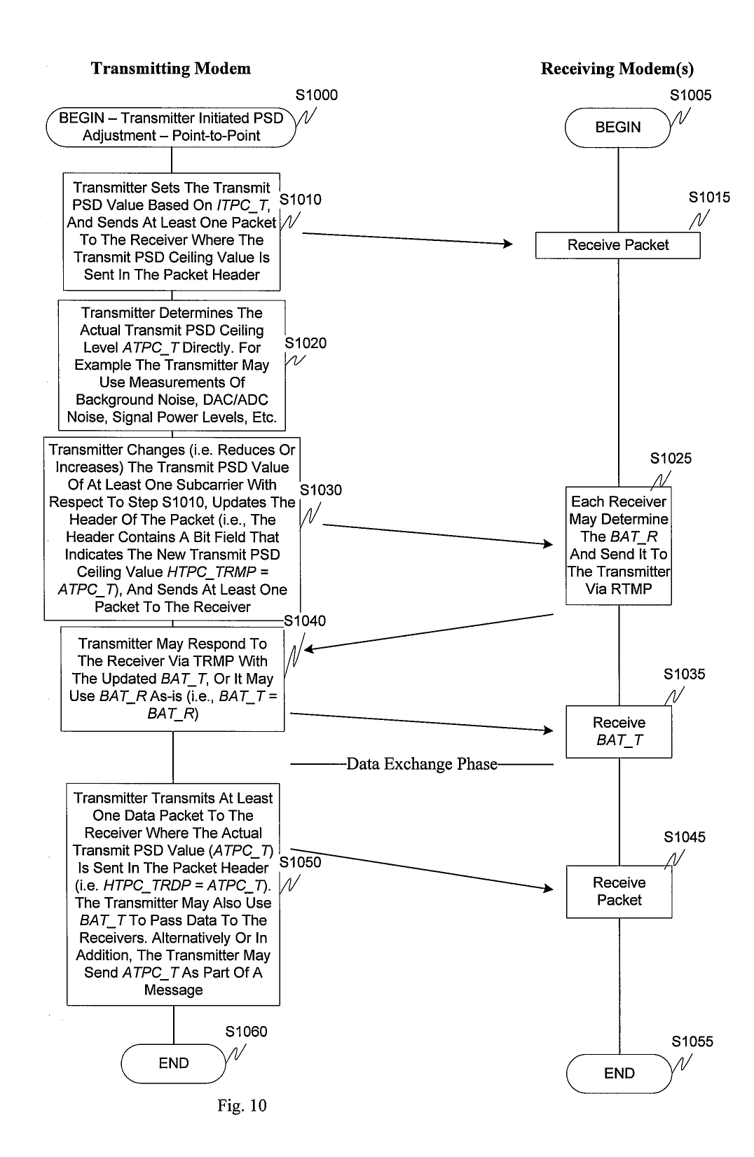

An exemplary method for transmitter-initiated PSD adjustment in a point-to-point communications environment includes one or more of the following steps as outlined in FIG. 10:

Control begins I step S1000 and continues to step S1010 where the transmitter sets the transmit PSD value based on ITPC_T, and sends at least one packet to the receiver, which receives it in step S1015, where the transmit PSD ceiling value is sent in the packet header. For example, the transmitter may send a packet with HTPC_TRMP=ITPC_T. Alternatively, or in addition, the transmitter may send ITPC_T as part of a message.

Next, in step S1020 the transmitter 100 determines the actual transmit PSD ceiling level ATPC_T directly. For example, the transmitter may use measurements of background noise, DAC/ADC noise, signal power levels, etc. Then, in step S1030, the transmitter changes (i.e., reduces or increases) the transmit PSD value of at least one subcarrier with respect to step S1010, updates the header of the packet (i.e., HTPC_TRMP=ATPC_T), and sends at least one packet to the receiver. Alternatively, or in addition, the transmitter may send ATPC_T as part of a message.

In step S1025, the receiver may determine the BAT_R and send it to the transmitter via RTMP. Next, in step S1040, the transmitter may respond to the receiver via TRMP with the updated BAT_T, or it may use BAT_R as-is (i.e., BAT_T=BAT_R).

In step S1050, and at the beginning of data exchange phase, the transmitter transmits at least one data packet to the receiver, which is received in step S1045, where the actual transmit PSD ceiling (ATPC_T) is sent in the packet header (i.e. HTPC_TRDP=ATPC_T). The transmitter may also use BAT_T to pass data to the receiver. Alternatively, or in addition, the transmitter may send ATPC_T as part of a message.

Point-to-Multipoint Communication

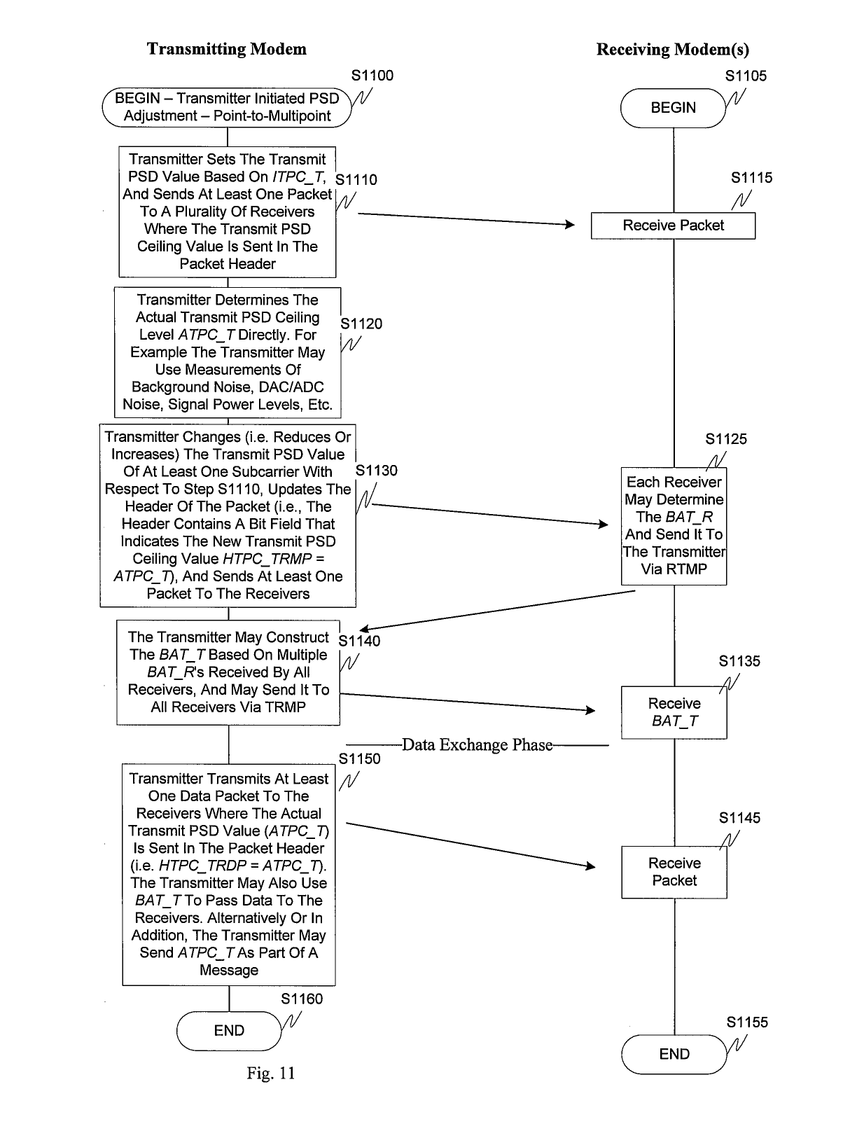

An exemplary method for transmitter-initiated PSD adjustment in a point-to-multipoint communications environment includes one or more of the following steps as outlined in FIG. 11:

Control begins in step S1100 and continues to step S1110. In step S1110, the transmitter sets the transmit PSD value based on (ITPC_T), and sends at least one packet to a plurality of receivers where the value of the transmit PSD ceiling value is sent in the packet header. For example, the transmitter may send a packet with HTPC_TRMP=ITPC_T. Alternatively, or in addition, the transmitter may send ITPC_T as part of a message.

Next, in step S1120, the transmitter determines the actual transmit PSD ceiling level ATPC_T directly. For example, the transmitter may use measurements of background noise, DAC/ADC noise, signal power levels, etc. Then, in step S1130, the transmitter changes (i.e., reduces or increases) the transmit PSD value of at least one subcarrier with respect to step S1110, updates the header of the packet (i.e., HTPC_TRMP=ATPC_T), and sends at least one packet to the receiver(s). Alternatively, or in addition, the transmitter may send ATPC_T as part of a message.

In step S1125, each receiver may determine the BAT_R and may send it to the transmitter via RTMP. Next, in step S1140, the transmitter may construct the BAT_T based on multiple BAT_R's received from all receivers, and may send it to all receivers via TRMP. Then, at the beginning of the data exchange phase in step S1150, the transmitter transmits at least one data packet to the receivers where the actual transmit PSD ceiling value is sent in the packet header (i.e. HTPC_TRDP=ATPC_T). The transmitter may also use BAT_T to pass data to the receiver(s). Alternatively, or in addition, the transmitter may send ATPC_T as part of a message.

Note that HTPC_X may not be necessary in the transmitter-based approach since the receivers do not need to know the actual transmit PSD level.

Data Exchange Phase

This section describes exemplary techniques and protocols used during the data exchange phase, which can be defined as a period where the transceivers exchange user data. The transmit PSD value power can be adjusted during the data exchange phase in order to one or more of dynamically adapt the time-varying channel and to save power. During the data exchange phase, TRDP is used as well as TRMP and RTMP.

Exemplary Receiver-Initiated Power Adjustment Method

Point-to-Point Communication

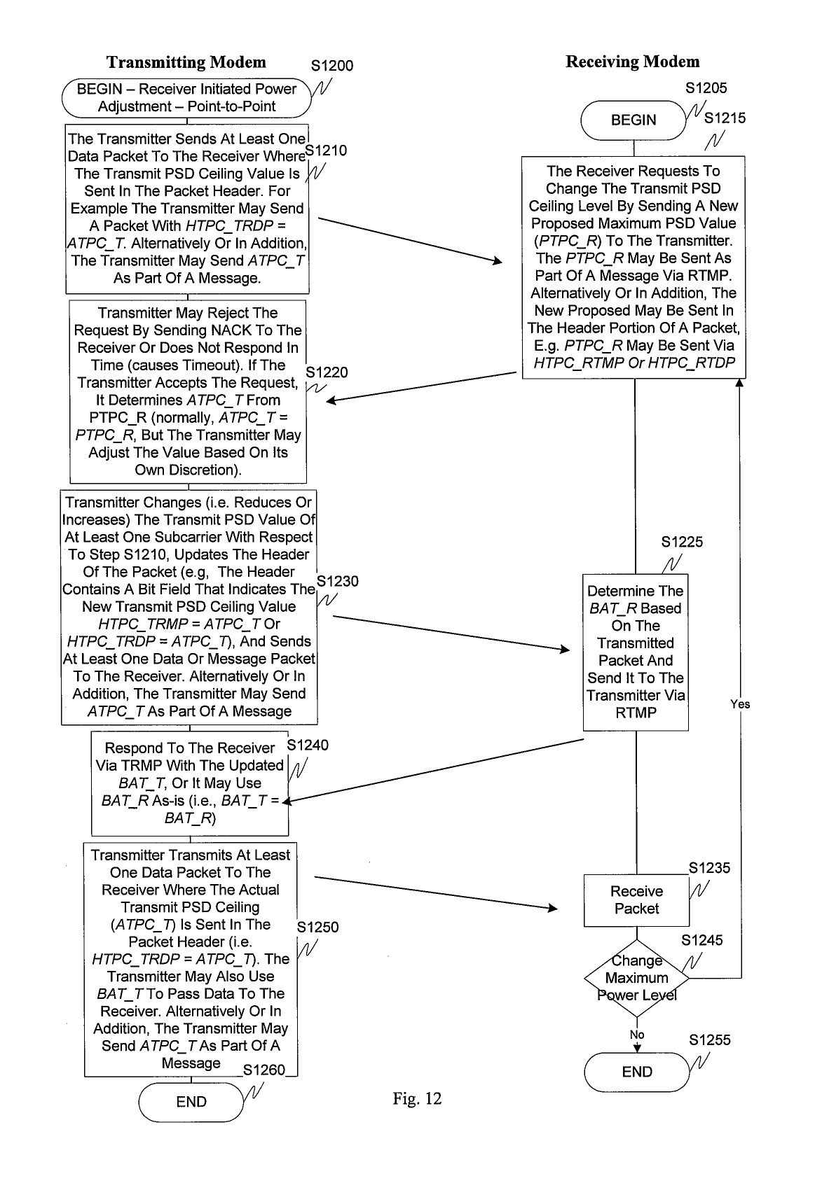

An exemplary method for receiver-initiated power adjustment in a point-to-point communications environment includes one or more of the following steps as outlined in FIG. 12:

Control begins in step S1200 and continues to step S1210. In step S1210, the transmitter sends at least one data packet to the receiver where the transmit PSD ceiling value is sent in the packet header. For example, the transmitter may send a packet with HTPC_TRDP=ATPC_T. Alternatively, or in addition, the transmitter may send ATPC_T as part of a message.

Next, in step S1215, the receiver requests to change the transmit PSD ceiling level by sending a new proposed maximum PSD value (PTPC_R) to the transmitter. The PTPC_R may be sent as part of a message via RTMP. Alternatively, or in addition, the new proposed PTPC_R may be sent in the header portion of a packet, e.g., PTPC_R may be sent via HTPC_RTMP or HTPC_RTDP.

Then, in step S1220, the transmitter may reject the request by sending, for example, a NACK (or equivalent signal or symbol) to the receiver, or may not respond in time (which causes a timeout). If the transmitter accepts the request, the transmitter determines ATPC_T from PTPC_R (normally, ATPC_T=PTPC_R, but the transmitter may adjust the value based on its own discretion).

In step S1230, the transmitter changes (i.e. reduces or increases) the transmit PSD value of at least one subcarrier with respect to step S1210, updates the header of the packet (e.g, HTPC_TRMP=ATPC_T or HTPC_TRDP=ATPC_T), and sends at least one data or message packet to the receiver. Alternatively, or in addition, the transmitter may send ATPC_T as part of a message.

Next, in step S1225, the receiver may determine the BAT_R based on the transmitted packet and may send the BAT_R to the transmitter via RTMP. Then, in step S1240, the transmitter may respond to the receiver via TRMP with the updated BAT_T, or it may use BAT_R as-is (i.e., BAT_T=BAT_R).

In step S1250, the transmitter transmits at least one data packet to the receive where the actual transmit PSD ceiling (ATPC_T) is sent in the packet header (i.e. HTPC_TRDP=ATPC_T). The transmitter may also use BAT_T to pass data to the receiver. Alternatively or in addition, the transmitter may send ATPC_T as part of a message.

Next, in step S1245, and after receipt of the packet in step S1235, if the receiving modem wants to change the maximum power level, control returns to step S1215. Control then continues to step S1255 where the control sequence ends.

Point-to-Multipoint Communication

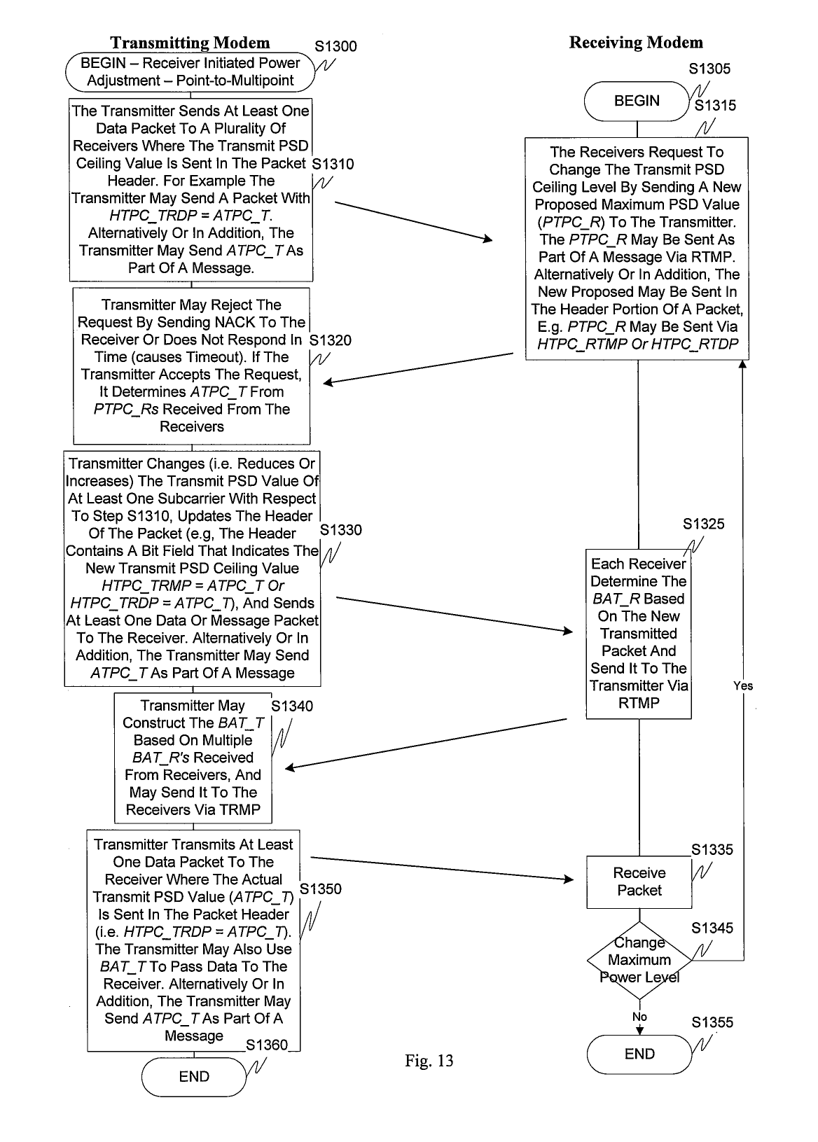

An exemplary method for receiver-initiated power adjustment in a point-to-multipoint communications environment includes one or more of the following steps as outlined in FIG. 13:

Control commences in step S1300 and continues to step S1310. In step S1310, the transmitter sends at least one data packet to a plurality of receivers where the transmit PSD ceiling value is sent in the packet header. For example the transmitter may send a packet with HTPC_TRDP=ATPC_T. Alternatively, or in addition, the transmitter may send ATPC_T as part of a message.

Next, in step S1315, the receivers request to change the transmit PSD ceiling level by sending a new proposed maximum PSD value (PTPC_R) to the transmitter. The PTPC_R may be sent as part of a message via RTMP. Alternatively, or in addition, the new proposed PTPC_R may be sent in the header portion of a packet, e.g., PTPC_R may be sent via HTPC_RTMP or HTPC_RTDP.

Then, in step S1320, the transmitter may reject the request by sending a NACK to the receivers or may not respond in time (causing a timeout). If the transmitter accepts the request, the transmitter determines ATPC_T from the PTPC_Rs received from the receivers. As discussed above, The ATPC_T may be determined from a plurality of PTPC_Rs in a number of ways.

In step S1330 the transmitter changes (i.e. reduces or increases) the transmit PSD value of at least one subcarrier with respect to step S1310, updates the header of the packet (i.e., HTPC_TRMP=ATPC_T or HTPC_TRDP=ATPC_T), and sends at least one data or message packet to the receivers. Alternatively, or in addition, the transmitter may send ATPC_T as part of a message.

Next, in step S1325, each receiver may determine a new BAT_R based on the new transmitted packet and may send it to the transmitter via RTMP. Then, in step S1340, the transmitter may construct the BAT_T based on multiple BAT_R's received from receivers, and may send the BAT_T to the receivers via TRMP.

Then, in step S1350, the transmitter transmits at least one data packet to the receivers where the actual transmit PSD ceiling (ATPC_T) is sent in the packet header (i.e. HTPC_TRDP=ATPC_T). The transmitter may also use BAT_T to pass data to the receiver. Alternatively, or in addition, the transmitter may send ATPC_T as part of a message.

In step S1345, and after receipt of the packet in step S1335, if the receiver wants to change the maximum power level again, control returns to step S1315.

Exemplary Transmitter-Initiated Power Adjustment Method

Point-to-Point Communication

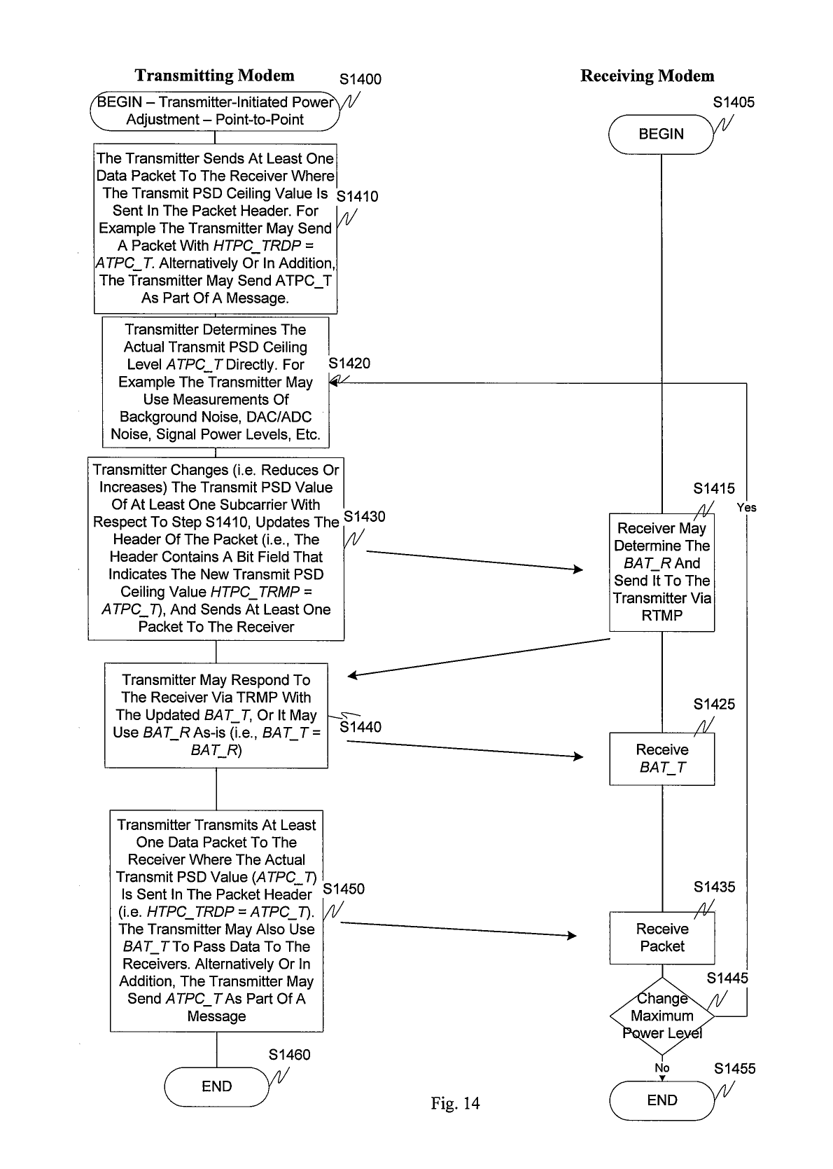

An exemplary method for transmitter-initiated power adjustment in a point-to-point communications environment includes one or more of the following steps as outlined in FIG. 14:

Control begins in step S1400 and continues to step S1410. In step S1410, the transmitter sends at least one data packet to the receiver where the transmit PSD ceiling value is sent in the packet header. For example, the transmitter may send a packet with HTPC_TRDP=ATPC_T. Alternatively, or in addition, the transmitting modem 100 may send ATPC_T as part of a message.

Next, in step S1420, the transmitter determines the actual transmit PSD ceiling level ATPC_T directly. For example, the transmitter may use measurements of background noise, DAC/ADC noise, signal power levels, etc. Then, in step S1430, the transmitter changes (i.e. reduces or increases) the transmit PSD value of at least one subcarrier with respect to step S1410, updates the header of the packet (i.e., HTPC_TRMP=ATPC_T or HTPC_TRDP=ATPC_T), and sends at least one data or message packet to the receiver. Alternatively, or in addition, the transmitter may send ATPC_T as part of a message.

In step S1415, the receiver may determine the BAT_R and send it to the transmitter via RTMP. Next, in step S1440, the transmitter may respond to the receiver 200 via TRMP with the updated BAT_T, or it may use BAT_R as-is (i.e., BAT_T=BAT_R).

Then, in step S1450, the transmitter transmits at least one data packet to the receiver where the actual transmit PSD ceiling (ATPC_T) is sent in the packet header (i.e. HTPC_TRDP=ATPC_T). The transmitter may also use BAT_T to pass data to the receiver. Alternatively, or in addition, the transmitter may send ATPC_T as part of a message.

In step S1445, after receipt of the packet in step S1435, if the transmitter wants to change the maximum power level again, control returns to step S1420.

Point-to-Multipoint Communication

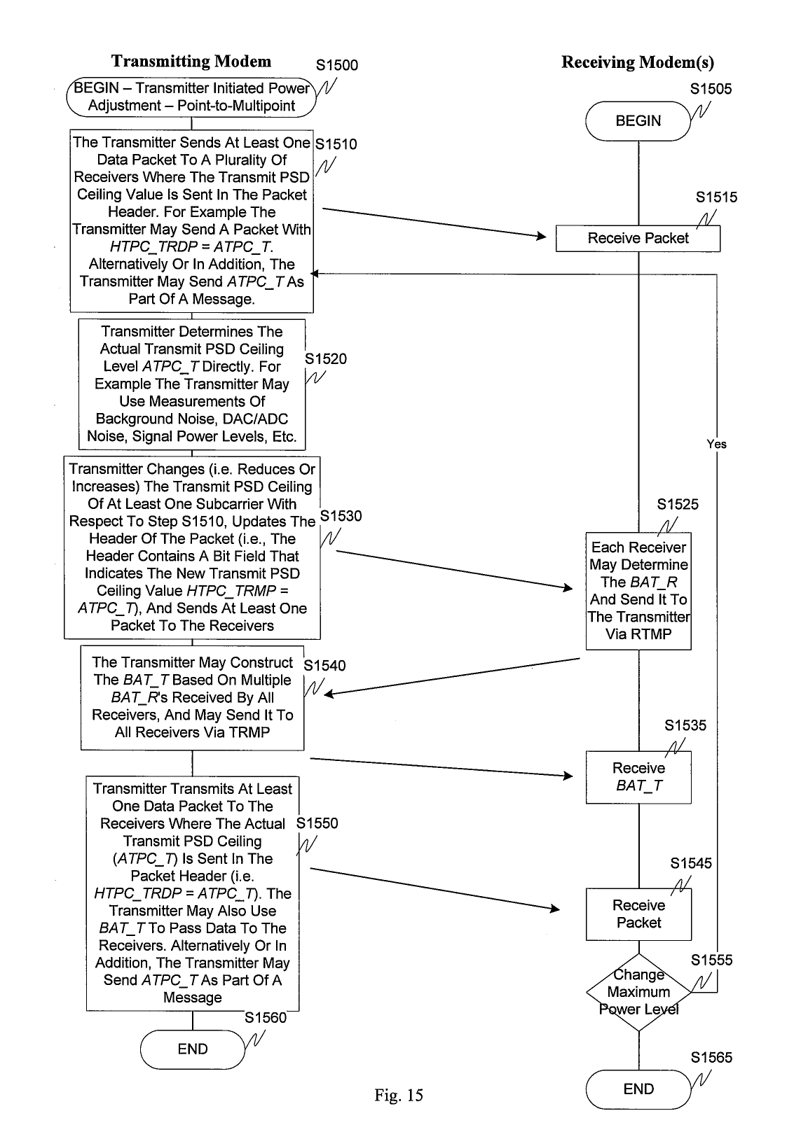

An exemplary method for transmitter-initiated power adjustment in a point-to-multipoint communications environment includes one or more of the following steps as outlined in FIG. 15.

Control begins in step S1500 and continues to step S1510. In step S1510, the transmitter sends at least one data packet to a plurality of receiving modems where the value of the transmit PSD ceiling value is sent in the packet header. For example, the transmitter may send a packet with HTPC_TRDP=ATPC_T. Alternatively, or in addition, the transmitter may send ATPC_T as part of a message.

Next, in step S1520, the transmitter determines the actual transmit PSD ceiling level ATPC_T directly. For example, the transmitter may use measurements of background noise, DAC/ADC noise, signal power levels, etc.

Then, in step S1530, the transmitter changes (i.e., reduces or increases) the transmit PSD value of at least one subcarrier with respect to step S1510, updates the header of the packet (i.e., HTPC_TRMP=ATPC_T or HTPC_TRDP=ATPC_T), and sends at least one message or data packet to the receivers. Alternatively, or in addition, the transmitter may send ATPC_T as part of a message.

In step S1525, each receiver may determine the BAT_R and may send it to the transmitter via RTMP. The transmitter may then construct in step S1540 the BAT_T based on multiple BAT_R's received from all the receivers, and may send the BAT_T to all receivers via TRMP.

Next, in step S1550, the transmitter transmits at least one data packet to the receivers where the actual transmit PSD ceiling (ATPC_T) is sent in the packet header (i.e. HTPC_TRDP=ATPC_T). The transmitter may also use BAT_T to pass data to the receivers. Alternatively, or in addition, the transmitter may send ATPC_T as part of a message.

Then, in step S1555, and after receipt of the packet in step S1545, if the transmitter wants to change the maximum power level again, control returns to step S1510.

Exemplary Power-Save Mode Transition Method

Point-to-Point Communication

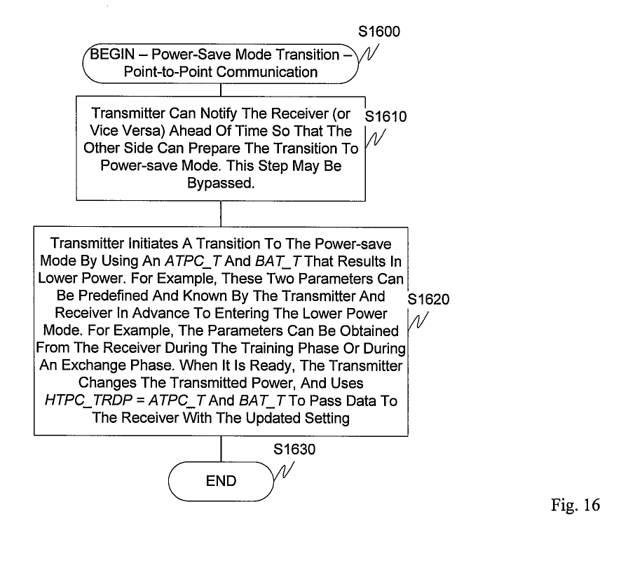

An exemplary method for a power-save mode transition in a point-to-point communications environment includes one or more of the following steps as outlined in FIG. 16:

Control begins in step S1600 and continues to step S1610. In step S1610, the transmitter can notify the receiver (or vice versa) ahead of time so that the other side can prepare the transition to power-save mode. Note, this optional step may be bypassed.

Next, in step S1620, the transmitter initiates a transition to the power-save mode by using an ATPC_T and BAT_T that results in lower power. For example, these two parameters can be predefined, known and stored in memory by the transmitter and receiver in advance to entering the lower power mode. For example, the parameters can be obtained from the receiver during the training phase or during a data exchange phase. When the transmitter is ready, the transmitter changes the transmitted power, and uses HTPC_TRDP=ATPC_T and BAT_T to pass data to the receiver with the updated setting. The transition out of power-save mode can be done in a similar manner.

The following illustrates exemplary simulation results that demonstrate the performance benefits of using the methods described in herein.

In order to evaluate the benefits of the Transmit PSD ceiling Level, we considered four scenarios for our simulations:

1-Band Flat −50: Employ a single band for transmission (single AFE with a single ADC setting the noise floor) with the transmit power spectral density (PSD) mask meeting the limits set by G.hn, ranging up to −50 dBm/Hz in the band [0 MHz, 30 MHz] and limited to −80 dBm/Hz for frequencies above 30 MHz.

1-Band Flat −80: Employ a single band for transmission (single AFE with a single ADC setting the noise floor) with the transmit power spectral density (PSD) mask limited to a maximum level of −80 dBm/Hz, even in the [0, 30 MHz] band.

Best Max TX PSD Value: Employ a single band for transmission (single AFE with a single ADC setting the noise floor) with a transmit PSD ceiling value (ceiling) chosen for the transmit power spectral density and applied to the basic G.hn PSD mask of scenario 1 (−50 dBm/Hz over [0 MHz, 30 MHz] and limit of −80 dBm/Hz at frequencies above 30 MHz). This transmit PSD ceiling value is adaptively chosen to produce the highest throughput given the channel response and disturbers present. The transmit PSD ceiling value results in a piecewise flat PSD mask, with the band [0 MHz, 30 MHz] set at the adaptively determined value between −80 dBm/Hz and −50 dBm/Hz, and the band above 30 MHz set at −80 dBm/Hz.

2-Band Flat −50: Employ two bands for transmission—one AFE for the [0, 50 MHz] band with its own ADC noise floor, and a second AFE for the [50 MHz, 100 MHz] or [50 MHz, 150 MHz] band with a separate ADC setting the noise floor in this second band. Transmit power spectral density is subject to the agreed spectral mask. We did not take into account any guard band or filtering to separate the two bands.

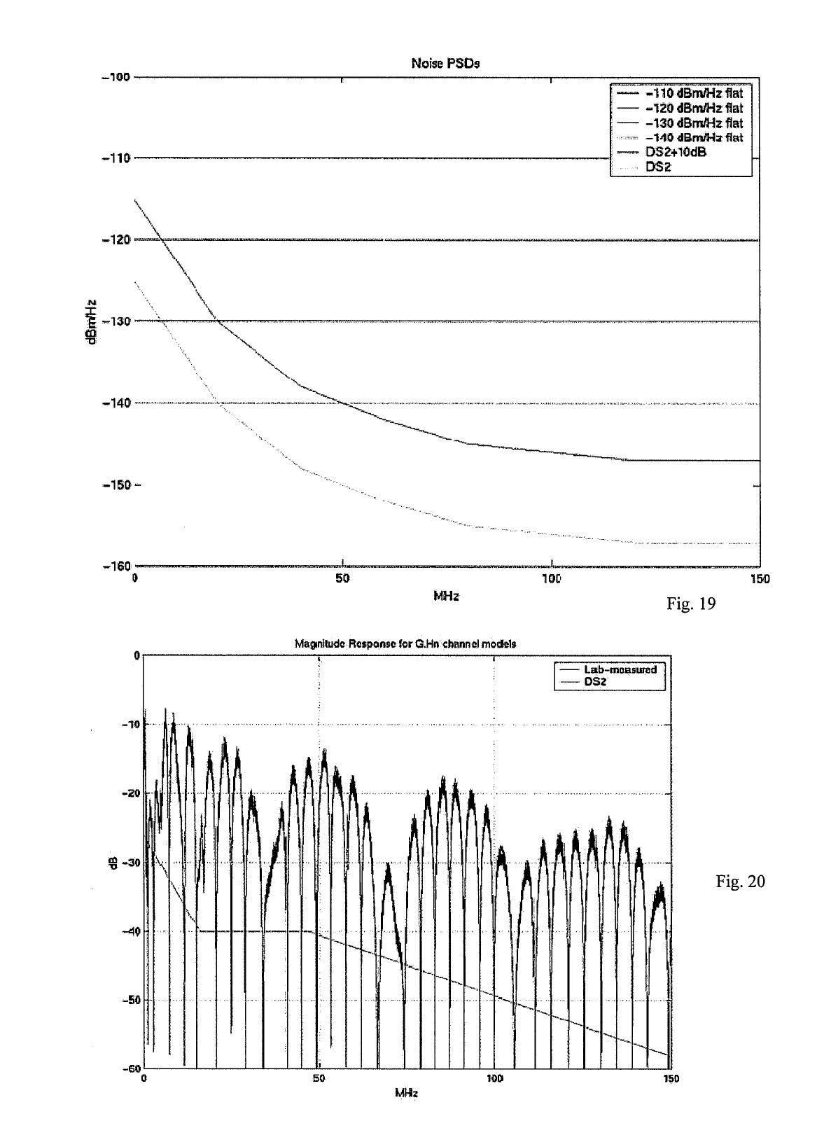

FIG. 19 shows Noise PSD used in the simulations. FIG. 20 shows the two channel models used in the simulations.

SIM1: Lab Measured Channel Model, Flat Noise
G.Hn data rates (Mbps) with 1-band and 2-band approaches for 100 Mhz and 150 MHz bandwidths.
Converters 10b referred to 200 Msps, flat noise at various levels

Band Division is at 50 MHz for 2-Band

flat noise level (dBm/Hz)

| | | −140 | −130 | −120 | −110 |
|---|---|---|---|---|---|
| 100 MHz | 1-band flat −80 | 898 | 666 | 402 | 170 |
| | 1-band flat −50 | 565 | 554 | 487 | 341 |
| | Best Max TX | 901 | 708 | 510 | 341 |
| | PSD Value | | | | |
| | 2-band flat −50 | 802 | 669 | 514 | 343 |
| 150 MHz | 1-band flat −80 | 1244 | 883 | 496 | 180 |
| | 1-band flat −50 | 688 | 669 | 560 | 349 |
| | Best Max TX | 1245 | 921 | 600 | 349 |
| | PSD Value | | | | |
| | 2-band flat −50 | 115 | 887 | 608 | 353 |
| 50 MHz | 1-band flat −80 | 470 | 365 | 320 | 106 |
| | 1-band flat −50 | 371 | 367 | 342 | 279 |
| | Best Max TX | 474 | 415 | 346 | 279 |
| | PSD Value | | | | |

Best Transmit PSD Ceiling Levels (dBm/Hz)

flat noise level (dBm/Hz)

| | −140 | −130 | −120 | −110 |
|---|---|---|---|---|
| 100 MHz | −77 | −68 | −57 | −50 |
| 150 MHz | −78 | −69 | −59 | −50 |
| 50 MHz | −74 | −65 | −55 | −50 |

SIM2: Lab Measured Channel Model, DS2 Noise
G.Hn data rates (Mbps) with 1-band and 2-band approaches for 100 Mhz and 150 MHz bandwidths.
Converters 10b referred to 200 Msps, noise model: DS2 at various levels

Band Division is at 50 MHz for 2-Band

| | | | | DS2 | DS2 |
|---|---|---|---|---|---|
| | | no | 20 dBm | ns +10 dB | ns −10 dB |
| | | con- | tx power | no con- | no con- |
| | | straint | constraint | straint | straint |
| 100 MHz | 1-band flat −80 | 941 | 941 | 827 | 973 |
| | 1-band flat −50 | 566 | 644 | 560 | 567 |
| | Best Max TX | 943 | 943 | 851 | 973 |
| | PSD Value | | | | |
| | 2-band flat −50 | 880 | 905 | 830 | 892 |
| 150 MHz | 1-band flat −80 | 1408 | 1408 | 1247 | 1443 |
| | 1-band flat −50 | 689 | 817 | 683 | 690 |
| | Best Max TX | 1408 | 1408 | 1253 | 1443 |
| | PSD Value | | | | |
| | 2-band flat −50 | 1375 | 1400 | 1266 | 1389 |
| 50 MHz | 1-band flat −80 | 462 | 462 | 369 | 491 |
| | 1-band flat −50 | 371 | 396 | 365 | 372 |
| | Best Max TX | 473 | 473 | 421 | 491 |
| | PSD Value | | | | |

SIM3: DS2 Channel Model, Flat Noise
G.Hn data rates (Mbps) with 1-band and 2-band approaches for 100 Mhz and 150 MHz bandwidths.
Converters 10b referred to 200 Msps, flat noise at various levels

Band Division is at 50 MHz for 2-Band

flat noise level (dBm/Hz)

| | | −140 | −130 | −120 | −110 |
|---|---|---|---|---|---|
| 100 MHz | 1-band flat −80 | 524 | 243 | 32 | 3 |
| | 1-band flat −50 | 564 | 407 | 235 | 161 |
| | Best Max TX | 622 | 409 | 235 | 161 |
| | PSD Value | | | | |
| | 2-band flat −50 | 604 | 413 | 235 | 161 |
| 150 MHz | 1-band flat −80 | 611 | 243 | 32 | 3 |
| | 1-band flat −50 | 615 | 407 | 235 | 161 |
| | Best Max TX | 705 | 409 | 235 | 161 |
| | PSD Value | | | | |
| | 2-band flat −50 | 691 | 413 | 235 | 161 |
| 50 MHz | 1-band flat −80 | 313 | 172 | 32 | 3 |
| | 1-band flat −50 | 392 | 342 | 235 | 161 |
| | Best Max TX | 415 | 343 | 235 | 161 |
| | PSD Value | | | | |

Best Transmit PSD Ceiling Levels (dBm/Hz)

flat noise level (dBm/Hz)

| | −140 | −130 | −120 | −110 |
|---|---|---|---|---|
| 100 MHz | −61 | −51 | −50 | −50 |
| 150 MHz | −61 | −51 | −50 | −50 |
| 50 MHz | −61 | −51 | −50 | −50 |

SIM4: DS2 Channel, DS2 Noise
G.Hn data rates (Mbps) with 1-band and 2-band approaches for 100 Mhz and 150 MHz bandwidths.
Converters 10b referred to 200 Msps, DS2 noise at various levels

Band Division is at 50 MHz for 2-Band

| | | | | DS2 | DS2 |
|---|---|---|---|---|---|
| | | no | 20 dBm | ns +10 dB | ns −10 dB |
| | | con- | tx power | no con- | no con- |
| | | straint | constraint | straint | straint |
| 100 MHz | 1-band flat −80 | 721 | 721 | 442 | 976 |
| | 1-band flat −50 | 614 | 686 | 557 | 627 |
| | Best Max TX | 788 | 788 | 576 | 990 |
| | PSD Value | | | | |
| | 2-band flat −50 | 805 | 824 | 628 | 945 |
| 150 MHz | 1-band flat −80 | 1039 | 1039 | 625 | 1399 |
| | 1-band flat −50 | 712 | 837 | 642 | 726 |
| | Best Max TX | 1078 | 1078 | 728 | 1400 |
| | PSD Value | | | | |
| | 2-band flat −50 | 1127 | 1146 | 811 | 1402 |
| 50 MHz | 1-band flat −80 | 318 | 318 | 178 | 456 |
| | 1-band flat −50 | 399 | 418 | 363 | 409 |
| | Best Max TX | 435 | 435 | 363 | 501 |
| | PSD Value | | | | |

The above-described methods and systems and can be implemented in a software module, a software and/or hardware testing module, a telecommunications test device, a DSL modem, an ADSL modem, an xDSL modem, a VDSL modem, a linecard, a G.hn transceiver, a MOCA transceiver, a Homeplug transceiver, a powerline modem, a wired or wireless modem, test equipment, a multicarrier transceiver, a wired and/or wireless wide/local area network system, a satellite communication system, network-based communication systems, such as an IP, Ethernet or ATM system, a modem equipped with diagnostic capabilities, or the like, or on a separate programmed general purpose computer having a communications device or in conjunction with any of the following communications protocols: CDSL, ADSL2, ADSL2+, VDSL1, VDSL2, HDSL, DSL Lite, IDSL, RADSL, SDSL, UDSL, MOCA, G.hn, Homeplug® or the like.

Additionally, the systems, methods and protocols of this invention can be implemented on a special purpose computer, a programmed microprocessor or microcontroller and peripheral integrated circuit element(s), an ASIC or other integrated circuit, a digital signal processor, a flashable device, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can be used to implement the various communication methods, protocols and techniques according to this invention. While the systems and means disclosed herein are described in relation to various functions that are performed, it is to be appreciated that the systems and means may not always perform all of the various functions, but are capable of performing one or more of the disclosed functions.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software that can be stored on a computer-readable medium, executed on programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of communication device.

While the invention is described in terms of exemplary embodiments, it should be appreciated that individual aspects of the invention could be separately claimed and one or more of the features of the various embodiments can be combined.

While the systems and means disclosed herein are described in relation to various functions that are performed, it is to be appreciated that the systems and means may not always perform all of the various functions, but are capable of performing one or more of the disclosed functions.

While the exemplary embodiments illustrated herein disclose the various components as collocated, it is to be appreciated that the various components of the system can be located at distant portions of a distributed network, such as a telecommunications network and/or the Internet or within a dedicated communications network. Thus, it should be appreciated that the components of the system can be combined into one or more devices or collocated on a particular node of a distributed network, such as a telecommunications network. As will be appreciated from the following description, and for reasons of computational efficiency, the components of the communications network can be arranged at any location within the distributed network without affecting the operation of the system.

It is therefore apparent that there has been provided, in accordance with the present invention, systems and methods for PSD management. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. In an OFDM packet-based transceiver, a method comprising:
generating a packet comprising a header;
encoding a transmit PSD ceiling value into a bit field contained in the header of a packet; and
transmitting the packet using a plurality of subcarriers.

2. In an OFDM packet-based transceiver, a method comprising:
receiving a packet using a plurality of subcarriers;
processing a header of the packet;
decoding a bit field in the header that contains the transmit PSD ceiling value.

3. (canceled)

4. The method of claim 1, wherein the transmit PSD value of at least one subcarrier is limited by the transmit PSD ceiling value.

5. The method of claim 1, wherein the PSD ceiling value is used to determine the PSD or limit the PSD of at least one subcarrier.

6.-44. (canceled)

45. In an OFDM packet-based system, a method comprising:
generating, in a first transceiver, a packet comprising a header;
encoding, in the first transceiver, a transmit PSD ceiling value into a bit field contained in the header of a packet;
transmitting, from the first transceiver, the packet using a plurality of subcarriers;
receiving, in a second transceiver, a packet using the plurality of subcarriers;
processing, in the second transceiver, the header of the packet; and
decoding, in the second transceiver, the bit field in the header that contains the transmit PSD ceiling value.

46.-347. (canceled)

348. The method of claim 2, wherein the transmit PSD value of at least one subcarrier is limited by the transmit PSD ceiling value.

349. The method of claim 2, wherein PSD ceiling value is used to determine the PSD or limit the PSD of at least one subcarrier.

350. The method of claim 45, wherein the transmit PSD value of at least one subcarrier is limited by the transmit PSD ceiling value.

351. The method of claim 45, wherein PSD ceiling value is used to determine the PSD or limit the PSD of at least one subcarrier.

352. An OFDM packet-based transceiver capable of generating a packet comprising a header, encoding a transmit PSD ceiling value into a bit field contained in the header of a packet, and transmitting the packet using a plurality of subcarriers.

353. The transceiver of claim 352, wherein the transmit PSD value of at least one subcarrier is limited by the transmit PSD ceiling value.

354. The transceiver of claim 352, wherein PSD ceiling value is used to determine the PSD or limit the PSD of at least one subcarrier.

355. An OFDM packet-based transceiver capable of receiving a packet using a plurality of subcarriers, processing a header of the packet, and decoding a bit field in the header that contains the transmit PSD ceiling value.

356. The transceiver of claim 355, wherein the transmit PSD value of at least one subcarrier is limited by the transmit PSD ceiling value.

357. The transceiver of claim 355, wherein PSD ceiling value is used to determine the PSD or limit the PSD of at least one subcarrier.

358. An OFDM packet-based system comprising:
a first transceiver capable of generating a packet comprising a header, encoding a transmit PSD ceiling value into a bit field contained in the header of a packet and transmitting, from the first transceiver, the packet using a plurality of subcarriers;
a second transceiver capable of receiving a packet using the plurality of subcarriers, processing the header of the packet, and decoding the bit field in the header that contains the transmit PSD ceiling value.

359. The system of claim 358, wherein the transmit PSD value of at least one subcarrier is limited by the transmit PSD ceiling value.

360. The system of claim 358, wherein PSD ceiling value is used to determine the PSD or limit the PSD of at least one subcarrier.

361. A non-transitory computer-readable information storage media having stored thereon instructions, that if executed by a processor, cause to be performed in an OFDM packet-based transceiver a method comprising:
generating a packet comprising a header;
encoding a transmit PSD ceiling value into a bit field contained in the header of a packet; and
transmitting the packet using a plurality of subcarriers.

362. The media of claim 361, wherein the transmit PSD value of at least one subcarrier is limited by the transmit PSD ceiling value.

363. The media of claim 361, wherein PSD ceiling value is used to determine the PSD or limit the PSD of at least one subcarrier.

364. A non-transitory computer-readable information storage media having stored thereon instructions, that if executed by a processor, cause to be performed in an OFDM packet-based transceiver a method comprising:
receiving a packet using a plurality of subcarriers;
processing a header of the packet;
decoding a bit field in the header that contains the transmit PSD ceiling value.

365. The media of claim 364, wherein the transmit PSD value of at least one subcarrier is limited by the transmit PSD ceiling value.

366. The media of claim 364, wherein PSD ceiling value is used to determine the PSD or limit the PSD of at least one subcarrier.

367. A non-transitory computer-readable information storage media having stored thereon instructions, that if executed by a processor, cause to be performed in an OFDM packet-based system a method comprising:
generating, in a first transceiver, a packet comprising a header;
encoding, in the first transceiver, a transmit PSD ceiling value into a bit field contained in the header of a packet;
transmitting, from the first transceiver, the packet using a plurality of subcarriers;
receiving, in a second transceiver, a packet using the plurality of subcarriers;
processing, in the second transceiver, the header of the packet; and
decoding, in the second transceiver, the bit field in the header that contains the transmit PSD ceiling value.

368. The media of claim 367, wherein the transmit PSD value of at least one subcarrier is limited by the transmit PSD ceiling value.

369. The media of claim 367, wherein PSD ceiling value is used to determine the PSD or limit the PSD of at least one subcarrier.
